(19) United States
(12) Patent Application Publication
(10) Pub. No.: US 2025/0171990 A1
(43) Pub. Date: May 29, 2025

(54) KITCHEN FAUCET ASSEMBLY

(71) Applicant: AS America, Inc., Piscataway, NJ (US)

(72) Inventors: Douglas F. LEAVITT, Bethlehem, PA (US); Emilie WILLIAMS, New York, NY (US); Verne MYERS, Fort Wayne, IN (US); Noelle GIBLIN, Spring Lake, NJ (US); Mahendra GUNAWARDENA, Hillsborough, NJ (US)

(73) Assignee: AS America, Inc., Piscataway, NJ (US)

(21) Appl. No.: 18/851,015

(22) PCT Filed: Mar. 31, 2023
(86) PCT No.: PCT/US2023/017110

§ 371 Date: Sep. 25, 2024

Related U.S. Application Data
(60) Provisional application No. 63/326,585, filed on Apr. 1, 2022.

(51) Int. Cl. E03C 1/05

(52) U.S. Cl. CPC E03C 1/055

(57) ABSTRACT

Provided are faucet assemblies comprising temperature control and/or a spray mode control. In some embodiments, a faucet assembly a faucet body having a fluid inlet; a fluid flow path within the faucet body fluidly connected to the fluid inlet; and a spray head; and a temperature control system positioned on the faucet body proximate to the spray head, the temperature control system having one or more controls configured to receive a user input comprising a user's desired fluid temperature; one or more lights configured to emit light based on the user input; and one or more circuit traces configured cause the mixing valve to control a temperature of the fluid based on the user's desired fluid temperature.

### CROSS-REFERENCE TO RELATED APPLICATIONS

This application claims the benefit of U.S. Provisional Application No. 63/326,585, filed Apr. 1, 2022, the entire contents of which is incorporated herein by reference.

### FIELD

The present disclosure generally relates to faucet assemblies. More specifically, the present disclosure relates to faucet assemblies comprising easy-to-reach temperature control mechanisms.

### BACKGROUND

Conventional faucets are designed to provide a continuous stream of water at a range of temperatures. Typically, a user of a conventional faucet may choose their desired water temperature using the same control that they use to turn the faucet on. In conventional faucets, this control is often a handle or a knob located near the base of the faucet body. In addition to allowing users to control the water temperature, conventional faucets often allow users to control or adjust water flow properties such as water pressure and spray pattern to a certain extent.

### SUMMARY

As mentioned above, a conventional faucet generally includes one or more controls (often handles or knobs) located near the base of the faucet body which are configured to both initiate the flow of water through the faucet and to control the temperature of the water. While conventional faucets do provide faucet users with some level of control over the water temperature, that control is often imprecise. For example, in many situations, a faucet user may wish to only marginally change the water temperature, but this may not be possible using an inaccurate control like a knob. Furthermore, since conventional faucet controls are generally located near the base of the faucet body, it is often inconvenient to adjust the water temperature while the faucet is on because adjusting the temperature would require the faucet user to reach through or around the stream of water being deposited from the faucet. There exists a need for a faucet assembly which provides a mechanism for faucet users to easily and precisely control water temperature.

Accordingly, the present disclosure provides a faucet assembly comprising a temperature control positioned near the faucet spray head. This position is easily accessible by faucet users and does not require faucet users to reach through or around a stream of water in order to control the temperature. The temperature control may be configured to receive a desired water temperature from a faucet user and, in turn, to transmit a signal to a mixing valve to control the water temperature. In some embodiments, the temperature control may include one or more indicator lights which are configured to provide the faucet user with a visual indication of a current water temperature or user's desired water temperature. This visual indication may provide the user with more accurate knowledge of the water temperature.

In some embodiments, the temperature control may be a linear assembly or a circular assembly of capacitive touch sensors disposed on the faucet body. Users may control the water temperature by swiping and/or pressing one or more of the capacitive touch sensors. The temperature control may control the water temperature based on which capacitive touch sensors receive user input.

In some embodiments, the temperature control may be an annular control comprising a magnetic temperature adjustment ring which is free to rotate about the faucet body. The annular control may be configured to detect a position of the temperature adjustment ring by measuring magnetic fields emitted by adjustment ring. The annular control may then control the water temperature based on the position of the adjustment ring.

In some embodiments, provided is a faucet assembly comprising: a faucet body comprising: a fluid inlet configured to fluidly connect to a mixing valve of a fluid source and receive fluid from the fluid source by way of the mixing valve; a fluid flow path within the faucet body fluidly connected to the fluid inlet and configured to receive fluid from the fluid inlet; and a spray head comprising one or more fluid outlets fluidly connected to the fluid flow path and configured to dispense fluid out of the faucet body; and a temperature control system positioned on the faucet body proximate to the spray head, the temperature control system comprising: a printed circuit board; one or more controls disposed on the printed circuit board and configured to receive a user input comprising a user's desired fluid temperature; one or more lights disposed on the printed circuit board and configured to emit light based on the user input; and one or more circuit traces disposed on the printed circuit board and configured to electronically connect to the mixing valve, the one or more controls, and the one or more lights; wherein, upon receiving the user input, the one or more controls are configured to transmit a signal to the mixing valve via the one or more circuit traces to cause the mixing valve to control a temperature of the fluid based on the user's desired fluid temperature.

In some embodiments of the faucet assembly, the one or more controls of the temperature control system comprise one or more capacitive touch sensors.

In some embodiments of the faucet assembly, the one or more controls of the temperature control system comprise one or more pressure sensors.

In some embodiments of the faucet assembly, the one or more controls of the temperature control system comprise one or more push buttons.

In some embodiments of the faucet assembly, the one or more controls of the temperature control system are arranged in a linear pattern.

In some embodiments of the faucet assembly, the one or more controls of the temperature control system are arranged in a circular pattern.

In some embodiments of the faucet assembly, the faucet assembly is configured to provide a plurality of spray modes.

In some embodiments of the faucet assembly, the faucet body further comprises a spray mode control comprising one or more spray mode regions, wherein each spray mode region is associated with a spray mode of the plurality of spray modes, and wherein each spray mode region is configured to: receive a spray mode input from the user; and control a flow of fluid through the one or more fluid outlets in order to initiate the spray mode associated with the spray mode region.

In some embodiments of the faucet assembly, the spray mode control comprises at least four spray mode regions.

In some embodiments of the faucet assembly, the spray mode control is a push button.

In some embodiments of the faucet assembly, the spray mode control is a capacitive touch sensor.

In some embodiments of the faucet assembly, the spray mode control is a pressure sensor.

In some embodiments of the faucet assembly, the faucet body further comprises a plurality of spray mode controls, wherein each of the plurality of spray mode controls is associated with a spray mode of the plurality of spray modes, and wherein each of the plurality of spray mode controls is configured to: receive a spray mode input from the user; and control a flow of fluid through the one or more fluid outlets in order to initiate the spray mode associated spray mode control.

In some embodiments of the faucet assembly, the plurality of spray mode controls comprises at least four spray mode controls.

In some embodiments of the faucet assembly, the plurality of spray mode controls comprises at least one push button.

In some embodiments of the faucet assembly, the plurality of spray mode controls comprises at least one capacitive touch sensor.

In some embodiments of the faucet assembly, the plurality of spray mode controls comprises at least one pressure sensor.

In some embodiments of the faucet assembly, the spray head is configured to pull away from the spout.

In some embodiments of the faucet assembly, the one or more lights are configured to emit light in a first wavelength range if the user's desired fluid temperature is within a first temperature range and are configured to emit light in a second wavelength range if the user's desired fluid temperature is within a second temperature range.

In some embodiments of the faucet assembly, the first wavelength range is 500-750 nm.

In some embodiments of the faucet assembly, the second wavelength range is 350-500 nm.

In some embodiments, a faucet assembly is provided, the faucet assembly comprising: a faucet body comprising: a fluid inlet configured to fluidly connect to a mixing valve of a fluid source and receive fluid from the fluid source by way of the mixing valve; a fluid flow path within the faucet body fluidly connected to the fluid inlet and configured to receive fluid from the fluid inlet; and a spray head comprising one or more fluid outlets fluidly connected to the fluid flow path and configured to dispense fluid out of the faucet body; and a temperature control system positioned on the faucet body proximate to the spray head, the temperature control system comprising: a printed circuit board; a magnetic ring configured to be rotated about the faucet body by a user; a magnetic ring position sensor configured to detect a rotation of the magnetic ring and determine a user's desired fluid temperature based on the detected rotation; one or more lights disposed on the printed circuit board and configured to emit light based on the detected rotation of the magnetic ring; and one or more circuit traces disposed on the printed circuit board and configured to electronically connect to the mixing valve, the magnetic ring position sensor, and the one or more lights; wherein, upon detecting the rotation of the magnetic ring, the magnetic ring position sensor is configured to transmit a signal to the mixing valve via the one or more circuit traces to cause the mixing valve to control a temperature of the fluid based on the user's desired fluid temperature.

In some embodiments of the faucet assembly, the faucet assembly is configured to provide a plurality of spray modes.

In some embodiments of the faucet assembly, the faucet body further comprises a spray mode control comprising one or more spray mode regions, wherein each spray mode region is associated with a spray mode of the plurality of spray modes, and wherein each spray mode region is configured to: receive a spray mode input from the user; and control a flow of fluid through the one or more fluid outlets in order to initiate the spray mode associated with the spray mode region.

In some embodiments of the faucet assembly, the spray mode control comprises at least four spray mode regions.

In some embodiments of the faucet assembly, the spray mode control is a push button.

In some embodiments of the faucet assembly, the spray mode control is a capacitive touch sensor.

In some embodiments of the faucet assembly, the spray mode control is a pressure sensor.

In some embodiments of the faucet assembly, the faucet body further comprises a plurality of spray mode controls, wherein each of the plurality of spray mode controls is associated with a spray mode of the plurality of spray modes, and wherein each of the plurality of spray mode controls is configured to: receive a spray mode input from the user; and control a flow of fluid through the one or more fluid outlets in order to initiate the spray mode associated spray mode control.

In some embodiments of the faucet assembly, the plurality of spray mode controls comprises at least four spray mode controls.

In some embodiments of the faucet assembly, the plurality of spray mode controls comprises at least one push button.

In some embodiments of the faucet assembly, the plurality of spray mode controls comprises at least one capacitive touch sensor.

In some embodiments of the faucet assembly, the plurality of spray mode controls comprises at least one pressure sensor.

In some embodiments of the faucet assembly, the spray head is configured to pull away from the spout.

In some embodiments of the faucet assembly, the one or more lights are configured to emit light in a first wavelength range if the user's desired fluid temperature is within a first temperature range and are configured to emit light in a second wavelength range if the user's desired fluid temperature is within a second temperature range.

In some embodiments of the faucet assembly, the first wavelength range is 500-750 nm.

In some embodiments of the faucet assembly, the second wavelength range is 350-500 nm.

In some embodiments, provided is a faucet assembly configured to provide a plurality of spray modes, the faucet assembly comprising: a faucet body comprising: a fluid inlet configured to fluidly connect to a mixing valve of a fluid source and receive fluid from the fluid source by way of the mixing valve; a fluid flow path within the faucet body fluidly connected to the fluid inlet and configured to receive fluid from the fluid inlet; and a spray head comprising one or more fluid outlets fluidly connected to the fluid flow path and configured to dispense fluid out of the faucet body; and a spray mode control system configured to receive a user input indicating a desired spray mode of the plurality of spray modes; wherein, upon receiving the user input indicating the desired spray mode, the spray mode control system is configured to control a flow of fluid through the one or more fluid outlets in order to initiate the user's desired spray mode.

In some embodiments of the faucet assembly, the spray mode control system comprises a spray mode control comprising one or more spray mode regions, wherein each spray mode region is associated with a spray mode of the plurality of spray modes, and wherein each spray mode region is configured to: receive a spray mode input from the user; and control a flow of fluid through the one or more fluid outlets in order to initiate the spray mode associated with the spray mode region.

In some embodiments of the faucet assembly, the spray mode control comprises at least four spray mode regions.

In some embodiments of the faucet assembly, the spray mode control is a push button.

In some embodiments of the faucet assembly, the spray mode control is a capacitive touch sensor.

In some embodiments of the faucet assembly, the spray mode control is a pressure sensor.

In some embodiments of the faucet assembly, the spray mode control system comprises a plurality of spray mode controls, wherein each of the plurality of spray mode controls is associated with a spray mode of the plurality of spray modes, and wherein each of the plurality of spray mode controls is configured to: receive a spray mode input from the user; and control a flow of fluid through the one or more fluid outlets in order to initiate the spray mode associated spray mode control.

In some embodiments of the faucet assembly, the plurality of spray mode controls comprises at least four spray mode controls.

In some embodiments of the faucet assembly, the plurality of spray mode controls comprises at least one push button.

In some embodiments of the faucet assembly, the plurality of spray mode controls comprises at least one capacitive touch sensor.

In some embodiments of the faucet assembly, the plurality of spray mode controls comprises at least one pressure sensor.

In some embodiments of the faucet assembly, the faucet body further comprises a temperature control system positioned on the faucet body proximate to the spray head, the temperature control system comprising: a printed circuit board; one or more controls disposed on the printed circuit board and configured to receive a user input comprising a user's desired fluid temperature; one or more lights disposed on the printed circuit board and configured to emit light based on the user input; and one or more circuit traces disposed on the printed circuit board and configured to electronically connect to the mixing valve, the one or more controls, and the one or more lights; wherein, upon receiving the user input, the one or more controls are configured to transmit a signal to the mixing valve via the one or more circuit traces to cause the mixing valve to control a temperature of the fluid based on the user's desired fluid temperature.

In some embodiments of the faucet assembly, the one or more controls of the temperature control system comprise one or more pressure sensors.

In some embodiments of the faucet assembly, the one or more controls of the temperature control system comprise one or more push buttons.

In some embodiments of the faucet assembly, the one or more controls of the temperature control system are arranged in a linear pattern.

In some embodiments of the faucet assembly, the one or more controls of the temperature control system are arranged in a circular pattern.

In some embodiments of the faucet assembly, the faucet body further comprises a temperature control system positioned on the faucet body proximate to the spray head, the temperature control system comprising: a printed circuit board; a magnetic ring configured to be rotated about the faucet body by a user; a magnetic ring position sensor configured to detect a rotation of the magnetic ring and determine a user's desired fluid temperature based on the detected rotation; one or more lights disposed on the printed circuit board and configured to emit light based on the detected rotation of the magnetic ring; and one or more circuit traces disposed on the printed circuit board and configured to electronically connect to the mixing valve, the magnetic ring position sensor, and the one or more lights; wherein, upon detecting the rotation of the magnetic ring, the magnetic ring position sensor is configured to transmit a signal to the mixing valve via the one or more circuit traces to cause the mixing valve to control a temperature of the fluid based on the user's desired fluid temperature.

In some embodiments of the faucet assembly, the spray head is configured to pull away from the spout.

In some embodiments of the faucet assembly, the one or more lights are configured to emit light in a first wavelength range if the user's desired fluid temperature is within a first temperature range and are configured to emit light in a second wavelength range if the user's desired fluid temperature is within a second temperature range.

In some embodiments of the faucet assembly, the first wavelength range is 500-750 nm.

In some embodiments of the faucet assembly, the second wavelength range is 350-500 nm.

### BRIEF DESCRIPTION OF THE FIGURES

The invention will now be described, by way of example only, with reference to the accompanying drawings.

FIGS. 1A-1B illustrates a faucet assembly with a temperature adjustment mechanism according to some embodiments of the present disclosure.

FIG. 2 illustrates a faucet with a temperature control assembly according to some embodiments of the present disclosure.

FIGS. 3A-3C illustrate perspective views of a faucet with a temperature control assembly according to some embodiments to the present disclosure.

FIG. 4 illustrates a cross-section of a temperature control assembly according to some embodiments of the present disclosure.

FIGS. 5A-5D illustrate cross-sections of various temperature control assembly configurations according to some embodiments of the present disclosure.

FIGS. 6A-6B illustrate perspective internal views of a faucet with a temperature control assembly according to some embodiments of the present disclosure.

FIGS. 7A-7B illustrate perspective internal views of a faucet with a temperature control assembly according to some embodiments of the present disclosure.

FIGS. 8A-8B illustrate perspective views of a temperature control assembly according to some embodiments of the present disclosure.

FIG. 9 illustrates a faucet with an temperature control assembly according to some embodiments of the present disclosure.

FIGS. 10A-10B illustrate perspective views of a faucet with an temperature control assembly according to some embodiments of the present disclosure.

FIG. 11 illustrates a faucet with an temperature control assembly according to some embodiments of the present disclosure.

FIG. 12 illustrates an temperature control assembly according to some embodiments of the present disclosure.

FIGS. 13A-13B illustrate perspective internal views of a faucet with an temperature control assembly according to some embodiments of the present disclosure.

FIG. 14 illustrates a faucet with an temperature control assembly according to some embodiments of the present disclosure.

FIG. 15 illustrates a faucet with a temperature control assembly according to some embodiments of the present disclosure.

FIGS. 16A-16B illustrate a temperature control assembly according to some embodiments of the present disclosure.

FIGS. 17A-17B illustrate spray control mechanisms for faucets according to some embodiments of the present disclosure.

FIGS. 18A-18D illustrate spray modes for faucets according to some embodiments of the present disclosure.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

### DETAILED DESCRIPTION

As discussed above, it is generally difficult to precisely control the water temperature of water deposited by a conventional faucet because the temperature controls of conventional faucets typically comprise one or more knobs or handles located near the base of the faucet. In addition, it is often inconvenient to adjust the water temperature while the faucet is on because adjusting the temperature would require the faucet user to reach through or around the stream of water being deposited from the faucet. As such, the present disclosure provides a faucet assembly comprising an easily accessible temperature control positioned near the faucet spray head.

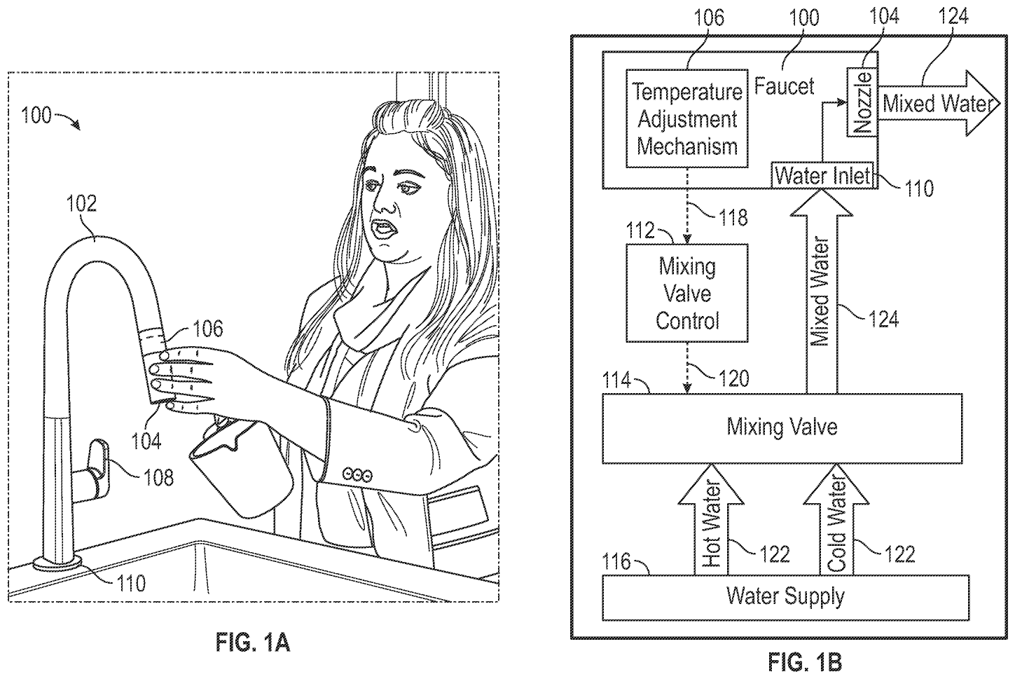

FIG. 1A illustrates a faucet assembly with a temperature adjustment mechanism according to some embodiments of the present disclosure. Specifically, FIG. 1A shows a faucet assembly 100 comprising a faucet body 102, a spray head 104, a temperature adjustment mechanism 106, a faucet handle 108, and a water inlet 110. In some embodiments, faucet assembly 100 may be configured to connect to a fluid source. Faucet body 102 may house a conduit configured to direct the flow of water from water inlet 110 to spray head 104. Spray head 104 may be configured to transmit water into a water receptacle (e.g., a kitchen sink, a bathroom sink, or a bathtub). In some embodiments, faucet assembly 100 may be a pull-out faucet or a pull-down faucet, i.e., spray head 104 may be connected to a hose housed within faucet body 102 and may be configured to be detached and pulled away from faucet body 102 by a faucet user.

In some embodiments, faucet handle 108 may be associated with a manual valve. Faucet handle 108 may be configured to cause water to flow from the fluid source and into faucet assembly 100 via water inlet 110. In some embodiments, faucet handle 108 may be configured to control a flow rate of water transmitted into the water receptacle. In some embodiments, faucet assembly 100 may comprise one or more controls in spray head 104 configured to control the water flow. In some embodiments, spray head 104 may comprise one or more controls configured to turn the faucet on/off, control the flow rate of water transmitted into the water receptacle, or to control a spray mode of water transmitted into the water receptacle.

Temperature adjustment mechanism 106 may be configured to receive a user input providing a desired water temperature. After receiving the user input providing the desired water temperature, temperature adjustment mechanism 106 may be configured to increase or decrease the temperature of water flowing through faucet body 102 and spray head 104. In some embodiments, temperature adjustment mechanism 106 may be configured to control the temperature of water flowing through faucet body 102 and spray head 104 by controlling a mixing valve. Temperature adjustment mechanism 106 may be configured to adjust the water temperature in real time as user inputs providing desired water temperatures are received.

In some embodiments, the mixing valve controlled by temperature adjustment mechanism 106 may be an electromechanical valve (e.g., a solenoid valve). In some embodiments, temperature adjustment mechanism 106 may be configured to control a first electromechanical valve for hot water and a second electromechanical valve for cold water. The first electromechanical valve and the second electromechanical valve may lead to a mixing chamber. In some embodiments, the mixing valve may be located upstream of a manual valve associated with faucet handle 108. In some embodiments, the mixing valve may be located upstream of a manual valve associated with faucet handle 108 and an electromechanical valve configured to control water flow rate. In some embodiments, the mixing valve may be located upstream of an electromechanical flow control valve. Alternative valve arrangements (possibly comprising one or more additional valves) may be conceivable.

In some embodiments, temperature adjustment mechanism 106 may be positioned between faucet body 102 and spray head 104. This may provide a faucet user with easy access to temperature adjustment mechanism 106 while the faucet user is using faucet assembly 100.

FIG. 1B shows a block diagram illustrating exemplary connections between faucet assembly 100, a mixing valve control 112, a mixing valve 114, and a fluid source 116. Fluid source 116 may comprise a hot fluid source and a cold fluid source and may be configured to transmit hot water and cold water to mixing valve 116 via separate water flow paths (e.g., separate pipes). In some embodiments, mixing valve control box 112 and mixing valve 114 may be housed beneath a water receptacle into which faucet assembly 100 is configured to deposit water.

In some embodiments, mixing valve 114 may be an electromechanical (e.g., solenoid) valve.

In some embodiments, temperature adjustment mechanism 106 may receive a user input from a faucet user. The user input may provide a desired water temperature. After receiving the user input, temperature adjustment mechanism 106 may be configured to transmit an input signal 118 to mixing valve control 112. Input signal 118 may be an electronic signal which may be transmitted wirelessly or via a wired connection between temperature adjustment mechanism 106 and mixing valve control 112.

After receiving input signal 118 from temperature adjustment mechanism 106, mixing valve control 112 may be configured to transmit a control signal 120 to mixing valve 114. Control signal 120 may comprise instructions configured to cause mixing valve to transmit water within a range of the faucet user's desired water temperature. In some embodiments, control signal 120 may be an electronic signal which may be transmitted wirelessly or via a wired connection between mixing valve control 112 and mixing valve 114.

Upon receiving control signal 120, mixing valve 114 may be configured to cause fluid source 116 to transmit water 122 to mixing valve 114. Water 122 may comprise hot water and cold water which may be separately transmitted to mixing valve 114. Mixing valve 114 may house a mixing chamber configured to allow the received hot water and the received cold water to mix. In some embodiments, mixing valve 114 may comprise a temperature sensor configured to track the temperature of water in the mixing chamber. In some embodiments, mixing valve 114 may be configured to adjust the ratio of hot water to cold water received from fluid source 116 in order to create water at the user's desired temperature.

After water 122 has been received and mixed within mixing valve 114, mixing valve 114 may be configured to transmit mixed water 124 to water inlet 110 of faucet 100. Water inlet 110 may be configured to transmit water 124 to spray head 104 via a fluid connection (e.g., faucet body 102 shown in FIG. 1A). At this point, water 124 may be transmitted by spray head 104 into a water receptacle.

Temperature adjustment mechanism 106 shown in FIGS. 1A-1B may take many forms. In some embodiments, temperature adjustment mechanism 106 may comprise a vertical control assembly configured to adjust the water temperature as the faucet user swipes a finger up or down a vertical array of sensors. In some embodiments, temperature adjustment mechanism 106 may comprise an annular assembly configured to adjust the water temperature as the faucet user twists an annular device wrapped around faucet body 102. In some embodiments, temperature control mechanism 106 may comprise a circular control assembly configured to adjust the water temperature as the faucet user swipes a finger around an array of sensor arranged in a circle.

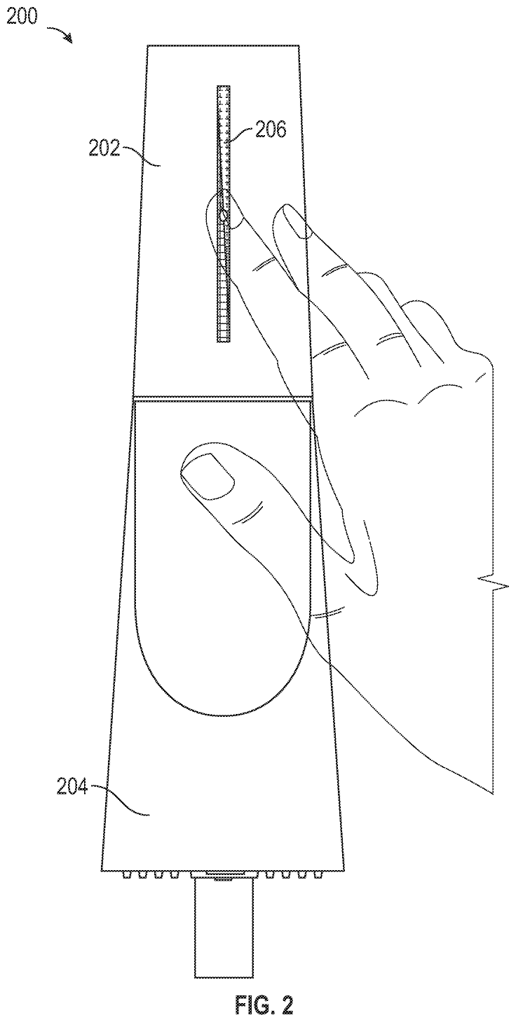

FIG. 2 illustrates a faucet with a temperature control assembly having a vertical configuration according to some embodiments of the present disclosure. Specifically, FIG. 2 illustrates a faucet 200 comprising a faucet body 202, a spray head 204, and a temperature control assembly 206. Faucet 200 may be configured to fluidly connect to a fluid source. In some embodiments, faucet body 202 may house a water conduit or a hose configured to transport water from a fluid source to spray head 204. Spray head 204 may be configured to transmit water into a water receptacle (e.g., a kitchen sink, a bathroom sink, or a bathtub).

In some embodiments, temperature control assembly 206 may include features of temperature control mechanism 106 as shown in FIGS. 1A-1B. Temperature control mechanism 206 may be configured to communicate with a mixing valve control (e.g., mixing valve control 112 shown in FIG. 1B) in order to control a mixing valve (e.g., mixing valve 114 shown in FIG. 1B) to cause water at the faucet user's desired water temperature to be deposited by spray head 204.

Temperature control assembly 206 may comprise one or more controls that are arranged in a line that follows the path from faucet body 202 to spray head 204 and are configured to receive input from a faucet user. In some embodiments, the one or more controls may be one or more capacitive touch sensors, one or more pressure sensors, one or more push buttons, a sliding switch, or a lever. In some embodiments, the faucet user may indicate a desired water temperature by touching and/or pressing a certain portion of temperature control mechanism 206. For example, temperature control assembly 206 may be configured to cause hot water to be deposited from spray head 204 when the faucet user provides input around a top portion of temperature control assembly 206 (e.g., a portion of temperature control assembly 206 that is farthest from spray head 204) and may be configured to cause cold water to be deposited from spray head 204 when the faucet user provides input around a bottom portion of temperature control assembly 206 (e.g., a portion of temperature control assembly that is closest to spray head 204). In some embodiments, the faucet user may lower or increase a current water temperature by swiping one or more fingers along one or more controls of temperature control assembly 206.

Temperature control assembly 206 may be configured to visually indicate the temperature of water currently being deposited from spray head 204 and/or to visually indicate a desired water temperature that the user has selected.

As shown in FIG. 2, temperature control assembly 206 may be positioned on faucet body 202 at a location proximal to spray head 204. This may provide the faucet user with easy access to temperature control assembly 206 while the faucet user is using faucet 200. In some embodiments, temperature control assembly 206 may be positioned on faucet body 202 at a location less than or equal to about 5, about 4, about 3, about 2, about 1, or about 0.5 inches from spray head 204. In some embodiments, temperature control assembly 206 may be positioned on faucet body 202 at a location greater than or equal to about 0.1, about 0.2, about 0.3, about 0.4, about 0.5, about 1, or about 1.5 inches from spray head 204.

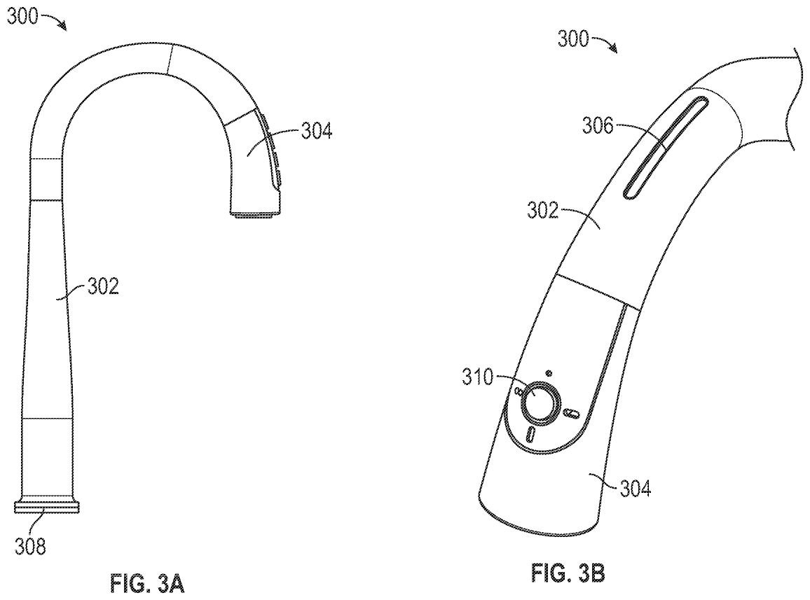

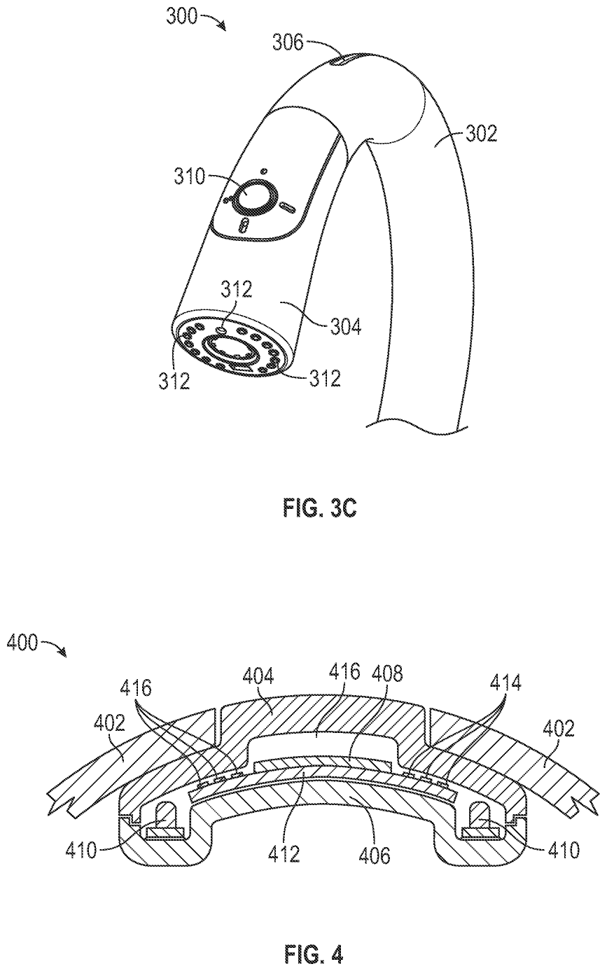

FIGS. 3A-3C illustrate perspective views of a faucet with a temperature control assembly according to some embodiments to the present disclosure. Specifically, FIGS. 3A-3C show perspective views of a faucet 300 comprising a temperature control assembly 306. In some embodiments, faucet 300 may comprise features of faucet 200 as shown in FIG. 2 or faucet 100 as shown in FIGS. 1A-1B. In particular, in some embodiments, temperature control assembly 306 may comprise features of temperature control assembly 206 shown in FIG. 2 or features of temperature control mechanism 106 shown in FIGS. 1A-1B.

FIG. 3A shows a side view of faucet 300. In some embodiments, faucet 300 may be configured to be mounted on a surface into which a water receptacle has been recessed. For example, faucet 300 may be mounted on a countertop above a kitchen sink. As shown, faucet 300 may comprise a faucet body 302, a spray head 304, and a water inlet 308. Water inlet 308 may be configured to receive water from a fluid source. After receiving water from the fluid source, water inlet 308 may be configured to transmit the water into a flow path housed by faucet body 302. In some embodiments, the flow path may comprise a conduit (e.g., a pipe) and/or a hose. The flow path may be configured to direct the water from faucet body 302 to spray head 304. Spray head 304 may be configured to transmit the water from faucet 300 to a water receptacle. In some embodiments, the flow of water through faucet 300 may be initiated when a faucet user moves one or more handles, knobs, and/or buttons. In some embodiments, faucet 300 may comprise a motion detector or presence sensor configured to detect the presence of the faucet user and, upon detecting said presence, initiate the flow of water through faucet 300.

FIG. 3B shows a view from above of the point of connection between faucet body 302 and spray head 304. As shown, temperature control assembly 306 may be positioned along faucet body 302 proximal to the point of connection between faucet body 302 and spray head 304. Temperature control assembly 306 may be configured to receive user input from a faucet user. After receiving the user input, temperature control assembly 306 may be configured to control a mixing valve based on information contained in the user input. In some embodiments, the user input may comprise information indicating a desired water temperature. In some embodiments, if faucet 300 is turned off when the faucet user provides the user input to temperature control assembly 306, temperature control assembly 306 may be configured to initiate the flow of water through faucet 300.

In some embodiments, faucet 300 may be configured to provide a plurality of spray modes. One or more of the plurality of spray modes may be configured to provide an aerated spray, a high pressure or jet spray, a low pressure spray, or a shower spray. Faucet 300 may comprise one or more spray mode controls 310 configured to allow the faucet user to selectively switch between the plurality of spray modes. In some embodiments, spray mode controls 310 may be positioned on spray head 304. Spray mode controls 310 may comprise one or more push buttons, pressure sensors, capacitive touch sensors, or switches.

FIG. 3C shows a view from below of the point of connection between faucet body 302 and spray head 304. As shown, spray head 304 may comprise a plurality of water outlets 312. In some embodiments, a portion of the plurality of water outlets 312 may be arranged in a circular pattern or in two or more concentric circular patterns. In some embodiments, spray head 304 may comprise greater than or equal to about 1, about 2, about 5, about 10, about 15, about 25, or about 50 water outlets 312. In some embodiments, spray head 304 may comprise less than or equal to about 100, about 50, about 25, about 15, or about 10 water outlets 312. In some embodiments, spray head 304 may comprise between about 1-5, about 1-10, about 10-15, about 15-25, about 25-50, or about 50-100 water outlets 312.

FIG. 4 illustrates a cross-section of a temperature control assembly having a vertical configuration according to some embodiments of the present disclosure. Specifically, FIG. 4 shows a cross-section of a temperature control assembly 400 disposed in an opening in a faucet body 402. Temperature control assembly 400 comprises a lens 404 which positioned atop a support 406. A plurality of capacitive touch sensors 408 along with a plurality of lights 410 are shown disposed on a printed circuit board 412. Printed circuit board 412 may comprise one or more circuit traces 414 configured to electrically connect one or more electronic components of temperature control assembly 400. In some embodiments, temperature control assembly 400 may be positioned along faucet body 402 in a location proximal to a spray head so that temperature control assembly 400 may be easily accessed by a faucet user.

In some embodiments, faucet body 402 may include features of faucet body 302 as shown in FIGS. 3A-3C, faucet body 202 as shown in FIG. 2, and/or faucet body 102 as shown in FIGS. 1A-1B. Faucet body 402 may house a water flow path (e.g., a hose) configured to direct water from a water inlet connected to a fluid source (e.g., water inlet 308 shown in FIG. 3A) to a plurality of water outlets in a faucet spray head (e.g., water outlets 312 in spray head 304 as shown in FIG. 3C). Faucet body 402 may be comprise copper, brass, stainless steel, zinc, pewter, bronze, glass, and/or ceramics. For example, in some embodiments, faucet body 402 may comprise pressure formed brass.

Lens 404 may be configured to be positioned at a location that is flush with the edges of an opening in faucet body 402. Lens 404 may comprise plastic and/or glass. In some embodiments, lens 404 may be greater than or equal to about 0.01. about 0.1, about 0.3, about 0.5, about 0.7, about 0.9, about 1.1, about 1.5, or about 2 cm thick at its point of maximum thickness. In some embodiments, lens 404 may be less than or equal to about 0.01. about 0.1, about 0.3, about 0.5, about 0.7, about 0.9, about 1.1, about 1.5, or about 2 cm thick at its point of maximum thickness. In some embodiments, lens 404 may be between about 0-0.1, about 0.1-0.3, about 0.3-0.5, about 0.5-0.7, about 0.7-0.9, about 0.9-1.1, about 1.1-1.5, about 1.5-1.7, or about 1.7-2 cm thick at its point of maximum thickness.

In some embodiments, temperature control assembly 400 may comprise a gap 416 between an inner surface of lens 404 and printed circuit board 412. This gap may be filled with an adhesive in order to protect printed circuit board 412 from water damage. In some embodiments, the adhesive may comprise thermoset high performance economical adhesives, epoxies, acrylics, polyurethanes, polyesters, and/or silicone. In some embodiments, thermoset adhesives may be applied via direct injection into gap 416. In some embodiments, thermoset adhesives may be pre-impregnated forms supplied from rolls or tapes which may be cut into an appropriate shape and then cured with heat, microwaves, or other energy supply methods. Once cured, the adhesives may provide permanent structure gap filling and sealing connection.

In some embodiments, capacitive touch sensors 408 and lights 410 may be configured to receive energy from a power source. The power source may comprise one or more batteries. In some embodiments, one or more circuit traces 414 and/or one or more wires may be configured to transmit energy from the power source to capacitive touch sensors 408 and lights 410.

A capacitive touch sensor of capacitive touch sensors 408 may be configured to receive user input from a faucet user when the faucet user touches a portion of lens 404 directly above the capacitive touch sensor. In some embodiments, when a capacitive touch sensor of capacitive touch sensors 408 receives user input from a faucet user, a signal may be transmitted to lights 410. The signal may be transmitted via one or more circuit traces 414 and may cause lights 410 to turn on. In some embodiments, lens 404 may be configured to direct light from lights 410 so that the light may be made visible to the faucet user.

Capacitive touch sensors 408 may be arranged in a line along faucet body 402. In some embodiments, the line of capacitive touch sensors 408 may follow a curve of faucet body 402 from a water inlet to a spray head. In some embodiments, a faucet user may adjust a water temperature by touching specific portions of lens 404, thereby providing user input to specific capacitive touch sensors 408. In some embodiments, temperature control assembly 400 may comprise at least about 1, about 2, about 3, about 4, about 5, about 10, about 20, or about 50 capacitive touch sensors 408. In some embodiments, temperature control assembly 400 may comprise less than or equal to about 100, about 75, about 50, about 30, about 20, about 15, about 10, or about 5 capacitive touch sensors 408. In some embodiments, temperature control assembly 400 may comprise between about 1-5, about 5-10, about 10-20, or about 20-50 capacitive touch sensors 408.

In some embodiments, temperature control assembly 400 may comprise one or more lights 410 on either side of each capacitive touch sensor 408. Lights 410 may comprise one or more LEDs soldered to printed circuit board 412. In some embodiments, lights 410 may be configured to emit light of any wavelength in the visible range of the electromagnetic spectrum. In some embodiments, one or more lights of lights 410 may be configured to emit light of different wavelengths, possibly simultaneously. In some embodiments, each light of lights 410 may be configured to emit the same wavelength of light at the same time. In some embodiments, the wavelength of light emitted by one or more lights of lights 410 may change as the faucet user provides input to capacitive touch sensors 408 indicating that they would like to increase or decrease their desired water temperature.

In some embodiments, the color of light emitted by lights 410 may change based on user input received by capacitive touch sensors 408. For example, if the faucet user indicates, using one or more sensors of capacitive touch sensors 408, that they wish their faucet to deposit hot water, lights 410 may be configured to emit light at a hot water indicator wavelength. In some embodiments, a hot water indicator wavelength may be less than or equal to about 750, about 625, about 590, or about 565 nm. In some embodiments, a hot water indicator wavelength may be greater than or equal to about 565, about 590, about 625, or about 750 nm. In some embodiments, a hot water indicator wavelength may be between about 500-565, about 565-590, about 590-625, or about 625-750 nm. Likewise, if the faucet user indicates, using one or more sensors of capacitive touch sensors 408, that they wish their faucet to deposit cold water, lights 410 may be configured to emit light at a cold water indicator wavelength. In some embodiments, a cold water indicator wavelength may be less than or equal to about 500, about 485, about 450, or about 380 nm. In some embodiments, a cold water indicator wavelength may be greater than or equal to about 380, about 450, about 485, or about 500 nm. In some embodiments, a cold water indicator wavelength may be between about 380-450, about 450-485, about 485-500, or about 500-565 nm.

As explained above, temperature control assembly 400 may be configured to be disposed inside faucet body 402. Lens 404 may fill a gap in faucet body 402 and face outward so that the faucet user may touch lens 404 and thus provide user input to capacitive touch sensors 408. Faucet body 402 have any shape, size, or style. In particular, a cross section of faucet body 402 may be of any shape and may have any cross-sectional area. In some embodiments, support 406 and printed circuit board 412 may be configured to bend and/or stretch in two or more directions in order to allow temperature control assembly 400 to be disposed inside faucet body 400 as described. Support 406 may comprise a thermoplastic (e.g., polypropylene or polyoxymethylene). The flexibility of support 406 and printed circuit board 412 may make temperature control assembly 400 amenable to mass manufacturing since it may be bent and/or stretched to fit inside a plurality of different faucet bodies without needing to be remade or customized.

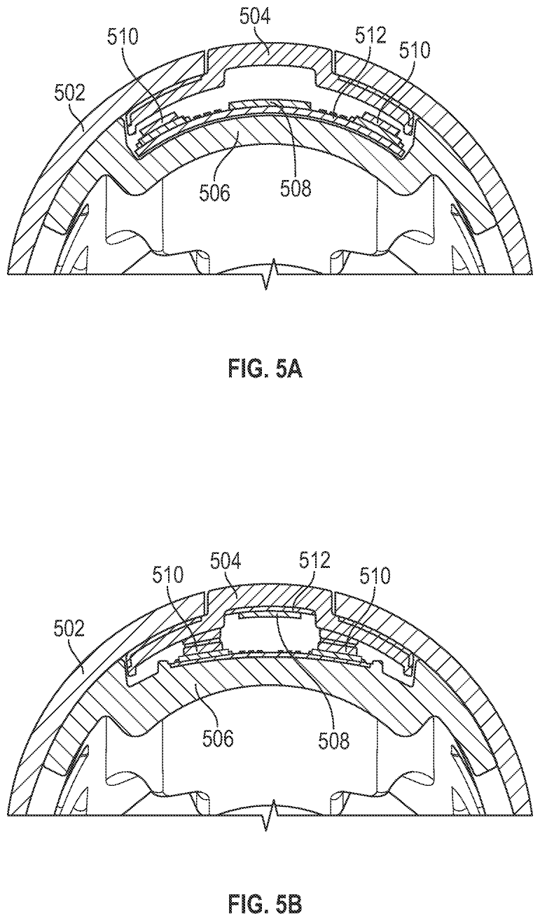

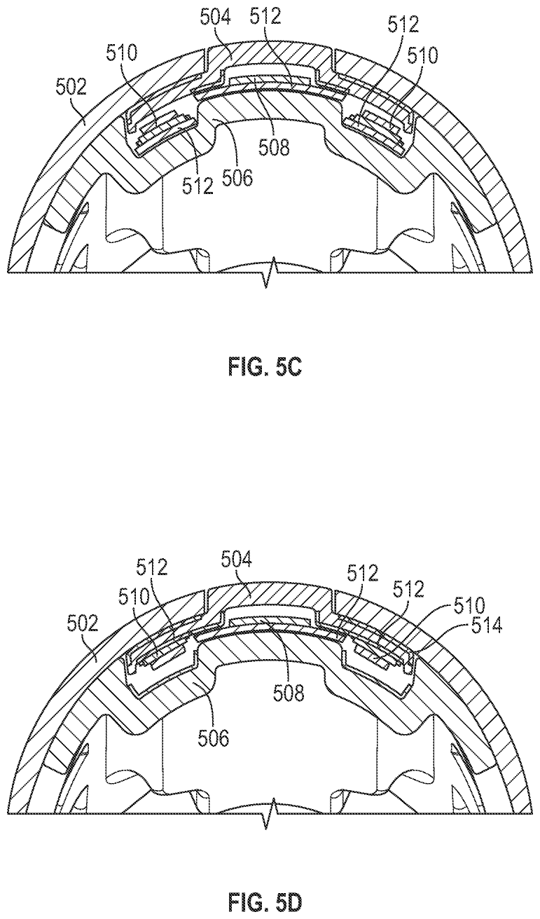

FIGS. 5A-5D illustrate cross-sections of various temperature control assembly configurations according to some embodiments of the present disclosure. Specifically, each of FIGS. 5A-5D show a temperature control assembly comprising a lens 504, a support 506, capacitive touch sensors 508, lights 510, and printed circuit board 512 disposed inside a faucet body 502. As shown, printed circuit board 512 may be separate from and disposed below lens 504 (FIGS. 5A and 5C) or partially affixed to lens 504 (FIGS. 5B and 5D). As such, in one or more examples, capacitive touch sensors 508 and/or lights 510 may be disposed below lens 504 (FIGS. 5A and 5C) or affixed to lens 504 (FIGS. 5B and 5D). A gap 514 between an inner surface of lens 504 and printed circuit board 512 disposed below lens 504 may vary in size and shape based on the configuration of capacitive touch sensors 508 and/or lights 510. In some embodiments, as shown in FIG. 5D, a temperature control assembly may include reflective material 514 configured to enhance a path of light emitted from lights 510.

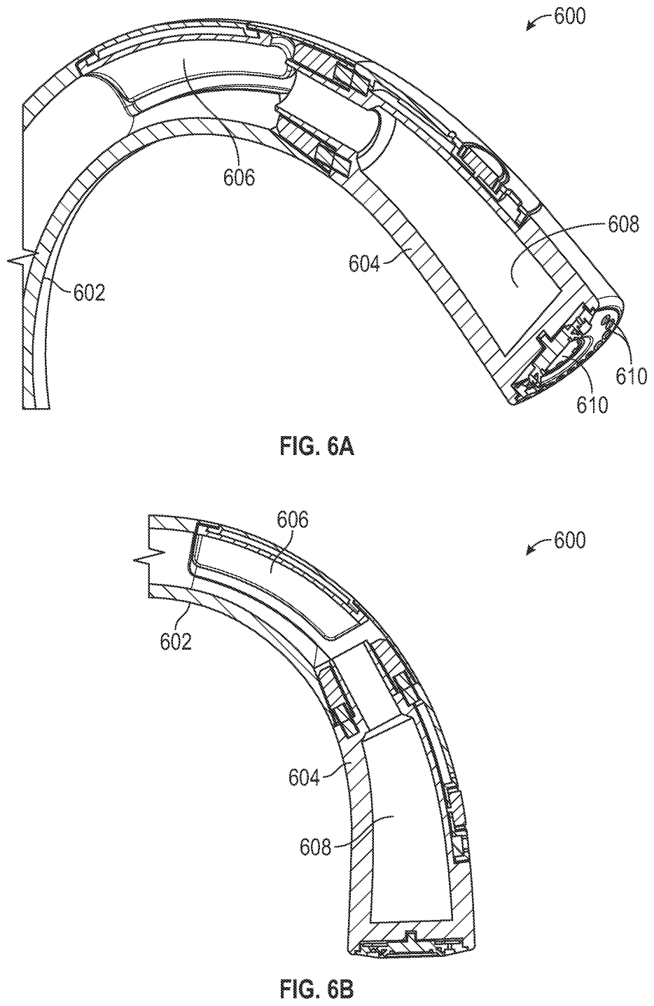

FIGS. 6A-6B illustrate perspective internal views of a faucet with a temperature control assembly having a vertical configuration according to some embodiments of the present disclosure. Specifically, FIGS. 6A-6D show a faucet 600 comprising a faucet body 602, a spray head 604 comprising a plurality of water outlets, and a temperature control assembly 606 disposed inside faucet body 602 proximal to spray head 604. In some embodiments, faucet body 602 may comprise an opening; when temperature control assembly 606 is disposed inside faucet body 602, a portion of temperature control assembly 606 comprising one or more user input sensors (e.g., capacitive touch sensors 408 shown in FIG. 4) may fill the opening. In some embodiments, temperature control assembly 606 may be configured to be affixed to an existing faucet 600.

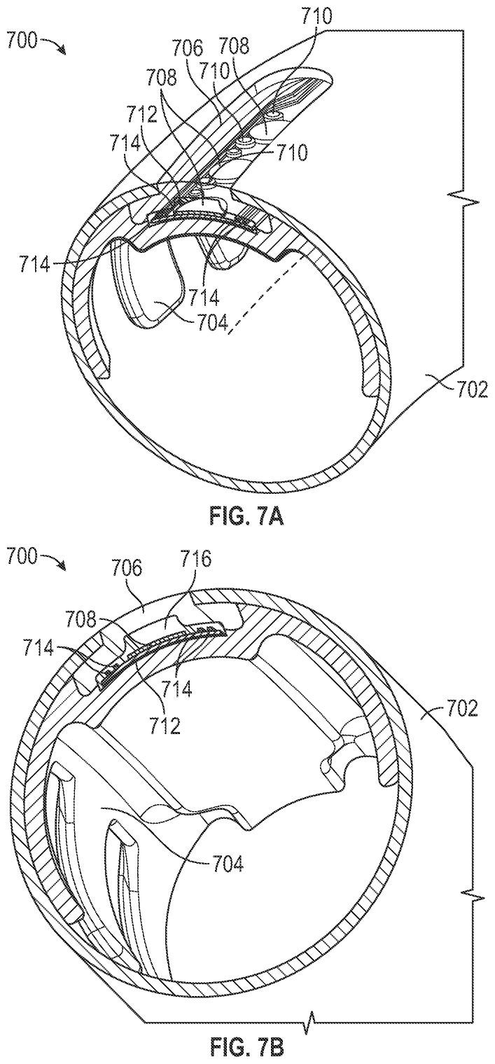

FIGS. 7A-7B illustrate perspective internal views of a faucet with a temperature control assembly having a vertical configuration according to some embodiments of the present disclosure. Specifically, FIGS. 7A-7B show internal views of a faucet body 702 of a faucet 700. A flexible support 704 may be disposed against an inner surface of faucet body 702. In some embodiments, flexible support 704 may be configured to be compressed so that it may be inserted into faucet body 702 during assembly of faucet 700. When flexible support 704 is inserted into an appropriate location, it may be configured to expand so that it is aligned with an inner surface of faucet body 702.

In some embodiments, a lens 706 may be affixed to flexible support 704 such that, when flexible support is disposed against the inner surface of faucet body 702, lens 706 may slide into an opening 718 in faucet body 702. In some embodiments, lens 706 may comprise features of lens 404 shown in FIG. 4.

In some embodiments, a printed circuit board 712 may be affixed to flexible support 704. In some embodiments, printed circuit board 712 may comprise features of printed circuit board 412 shown in FIG. 4. Printed circuit board 712 may comprise one or more capacitive touch sensors 708 configured to receive user input from a faucet user indicating the user's desired water temperature. In some embodiments, printed circuit board 712 may comprise one or more lights 710 configured to emit light in response to a user input received by capacitive touch sensor 708. One or more circuit traces 714 may be configured to transmit electrical signals between capacitive touch sensors 708 and lights 710. In some embodiments, one or more circuit traces 714 may be configured to transmit electrical signals from capacitive touch sensors 708 to a mixing valve and/or a mixing valve control (e.g., mixing valve control 112 of FIG. 1) in response to inputs received from a faucet user by capacitive touch sensors 708. In some embodiments, capacitive touch sensors 708 and/or lights 710 may comprise features of capacitive touch sensors 408 and/or lights 410 shown in FIG. 4.

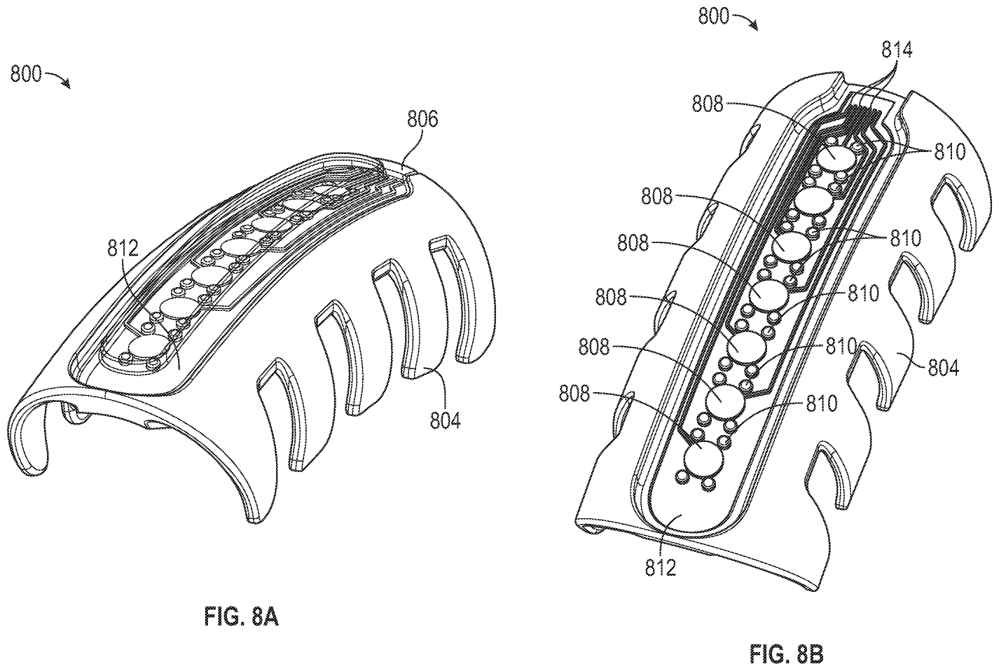

FIGS. 8A-8B illustrate perspective views of a temperature control assembly having a vertical configuration according to some embodiments of the present disclosure. Specifically, FIGS. 8A-8B show perspective views of a temperature control assembly 800 comprising a flexible support 804, a lens 806, and a printed circuit board 812 upon which a plurality of capacitive touch sensors 808 and a plurality of lights 810 are disposed. Printed circuit board 812 may comprise a plurality of circuit traces 814 configured to transmit electrical signals between capacitive touch sensors 808 and lights 810. In some embodiments, one or more circuit traces 814 may be configured to transmit electrical signals from capacitive touch sensors 808 to a mixing valve and/or a mixing valve control (e.g., mixing valve control 112 of FIG. 1) in response to inputs received from a faucet user by capacitive touch sensors 808. Temperature control assembly 800 may comprise features of temperature control assembly 400 shown in FIG. 4 and/or of temperature control assembly 206 shown in FIG. 2.

In some embodiments, flexible support 804 may comprise features of flexible support 704 shown in FIG. 7 and/or support 406 shown in FIG. 4. Flexible support 804 may comprise a plurality of legs 816. One or more of the plurality of legs 816 may be configured to bend inward (toward the center of temperature control assembly 800) and/or outward (away from temperature control assembly 800). In some embodiments, one or more of the plurality of the plurality of legs 816 may be configured to move independently from other legs 816. In some embodiments, the flexibility of flexible support 804 may increase with an increased number of legs 816. In some embodiments, flexible support 804 may comprise less than or equal to about 30, about 25, about 20, about 15, about 10, about 8, about 5 or about 3 legs 816. In some embodiments, flexible support 804 may comprise greater than or equal to about 35, about 30, about 25, about 20, about 15, about 10, about 8, or about 5 legs 816. In some embodiments, flexible support 804 may comprise between about 5-10, about 10-15, about 15-20, or about 20-25 legs. Each of the plurality of legs 816 may be of the same length or may be of different lengths. In some embodiments, one or more of the plurality of legs 816 may be less than or equal to about 0.1, about 0.5, about 0.8, about 1, about 1.5, about 2, or about 5 inches long. In some embodiments, one or more of the plurality of legs 816 may be greater than or equal to about 0.1, about 0.5, about 0.8, about 1, about 1.5, about 2, or about 5 inches long. In some embodiments, one or more of the plurality of legs 816 may be between about 0-0.1, about 0-0.5, about 0-0.8, about 0-1, or about 0-5 inches long.

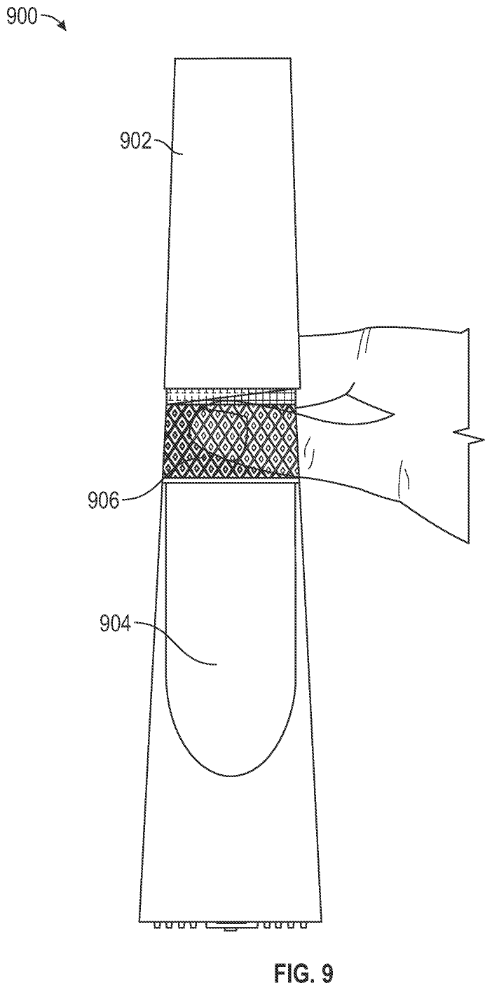

FIG. 9 illustrates a faucet with an temperature control assembly having an annular configuration according to some embodiments of the present disclosure. Specifically, FIG. 9 shows a faucet 900 comprising a faucet body 902, a spray head 804, and an temperature control assembly 906. Faucet 900 may be configured to fluidly connect to a fluid sourcefluid source. In some embodiments, faucet body 902 may house a water conduit or a hose configured to transport water from a fluid source to spray head 904. Spray head 904 may be configured to transmit water into a water receptacle (e.g., a kitchen sink, a bathroom sink, or a bathtub).

In some embodiments, temperature control assembly 906 may include features of temperature control mechanism 106 as shown in FIGS. 1A-1B. Temperature control mechanism 906 may be configured to communicate with a mixing valve control (e.g., mixing valve control 112 shown in FIG. 1B) in order to control a mixing valve (e.g., mixing valve 114 shown in FIG. 1B) to cause water at the faucet user's desired water temperature to be deposited by spray head 904.

Temperature control assembly 906 may comprise one or more ring controls that wrap around faucet body 902. The one or more ring controls may be configured to rotate freely around faucet body 902. In some embodiments, a faucet user may provide user input indicating a desired water temperature by rotating the one or more ring controls around faucet body 902. In some embodiments, temperature control assembly 906 may be configured to visually indicate the temperature of water currently being deposited from spray head 904 and/or to visually indicate a desired water temperature that the user has selected.

As shown in FIG. 9, temperature control assembly 906 may be positioned on faucet body 902 at a location proximal to spray head 904. This may provide the faucet user with easy access to temperature control assembly 906 while the faucet user is using faucet 900. In some embodiments, temperature control assembly 906 may be positioned on faucet body 902 at a location less than or equal to about 5, about 4, about 3, about 2, about 1, or about 0.5 inches from spray head 904. In some embodiments, temperature control assembly 906 may be positioned on faucet body 902 at a location greater than or equal to about 0.1, about 0.2, about 0.3, about 0.4, about 0.5, about 1, or about 1.5 inches from spray head 904.

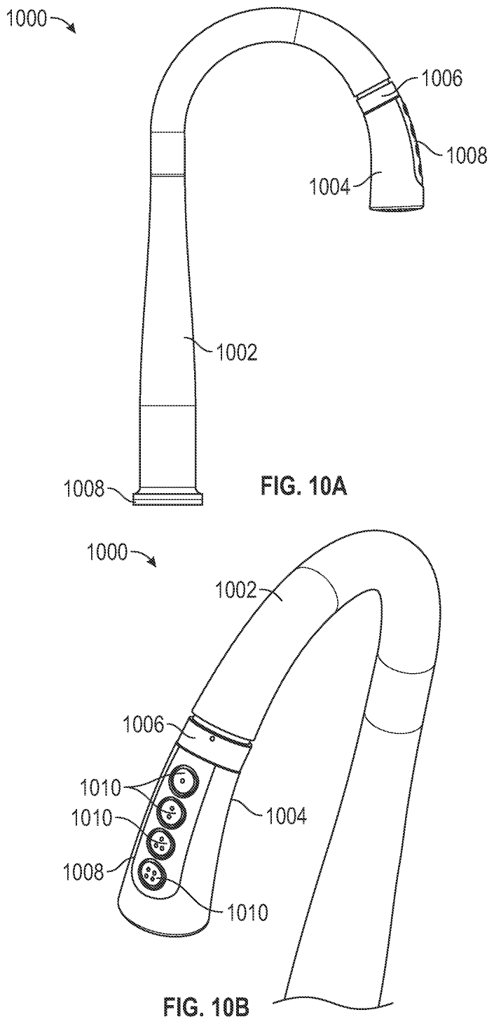

FIGS. 10A-10B illustrate perspective views of a faucet with an temperature control assembly having an annular configuration according to some embodiments of the present disclosure. Specifically, FIGS. 10A-10B show perspective views of a faucet 1000 comprising an temperature control assembly 1006. In some embodiments, faucet 1000 may comprise features of faucet 900 as shown in FIG. 9 or faucet 100 as shown in FIGS. 1A-1B. In particular, in some embodiments, temperature control assembly 1006 may comprise features of temperature control assembly 906 shown in FIG. 9 or features of temperature control mechanism 106 shown in FIGS. 1A-1B.

FIG. 10A shows a side view of faucet 1000. In some embodiments, faucet 1000 may be configured to be mounted on a surface into which a water receptacle has been recessed. For example, faucet 1000 may be mounted on a countertop above a kitchen sink. As shown, faucet 1000 may comprise a faucet body 1002, a spray head 1004, and a water inlet 1008. Water inlet 1008 may be configured to receive water from a fluid source. After receiving water from the fluid source, water inlet 1008 may be configured to transmit the water into a flow path housed by faucet body 1002. In some embodiments, the flow path may comprise a conduit (e.g., a pipe) and/or a hose. The flow path may be configured to direct the water from faucet body 1002 to spray head 1004. Spray head 1004 may be configured to transmit the water from faucet 1000 to a water receptacle. In some embodiments, the flow of water through faucet 1000 may be initiated when a faucet user moves one or more handles, knobs, and/or buttons. In some embodiments, faucet 1000 may comprise a motion detector or presence sensor configured to detect the presence of the faucet user and, upon detecting said presence, initiate the flow of water through faucet 1000.

FIG. 10B shows a view from above of the point of connection between faucet body 1002 and spray head 1004. As shown, temperature control assembly 1006 may be positioned along faucet body 1002 proximal to the point of connection between faucet body 1002 and spray head 1004. Temperature control assembly 1006 may be configured to receive user input from a faucet user. After receiving the user input, temperature control assembly 1006 may be configured to control a mixing valve based on information contained in the user input. In some embodiments, the user input may comprise information indicating a desired water temperature. In some embodiments, if faucet 1000 is turned off when the faucet user provides the user input to temperature control assembly 1006, temperature control assembly 1006 may be configured to initiate the flow of water through faucet 1000.

In some embodiments, faucet 1000 may be configured to provide a plurality of spray modes. One or more of the plurality of spray modes may be configured to provide an aerated spray, a high pressure or jet spray, a low pressure spray, or a shower spray. Faucet 1000 may comprise one or more spray mode controls 1010 configured to allow the faucet user to selectively switch between the plurality of spray modes. In some embodiments, spray mode controls 1010 may be positioned on spray head 1004. Spray mode controls 1010 may comprise one or more push buttons, pressure sensors, capacitive touch sensors, or switches.

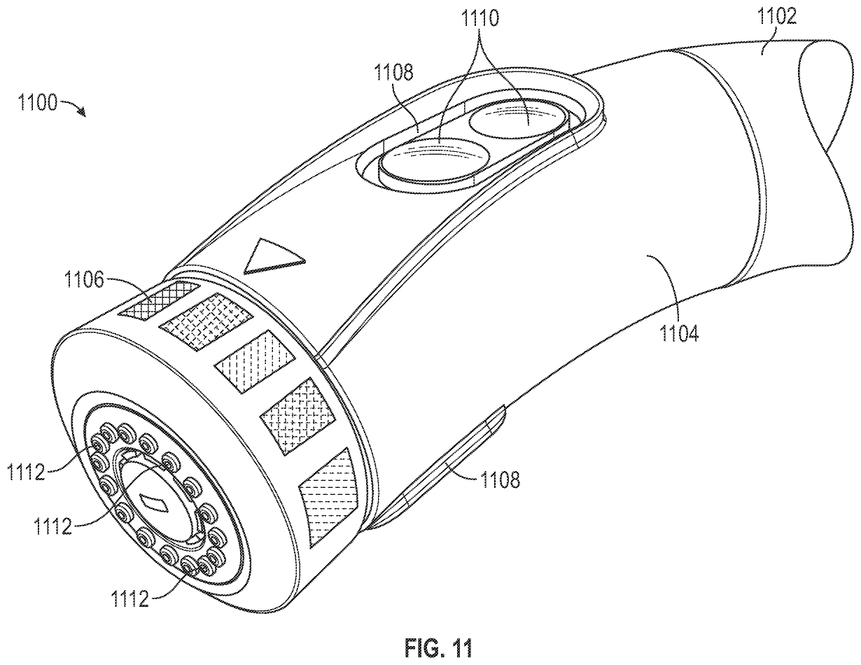

FIG. 11 illustrates a faucet with an temperature control assembly having an annular configuration according to some embodiments of the present disclosure. Specifically, FIG. 11 show a faucet 1100 comprising a faucet body 1102, a spray head 1104 comprising a plurality of water outlets 1112, and an temperature control assembly 1106. In some embodiments, temperature control assembly 1106 may be positioned on spray head 1104.

In some embodiments, faucet 1100 may comprise one or more water flow controls 1110. One or more water flow controls 1100 may be configured to control one or more valves in order to initiate and/or halt a flow of water from a fluid source to faucet 1100. One or more water flow controls 1100 may be configured to cause faucet 1100 to deposit filtered water. Water flow controls 1100 may be positioned on spray head 1104.

Faucet 1100 may be configured to provide a plurality of spray modes. One or more of the plurality of spray modes may be configured to provide an aerated spray, a high pressure or jet spray, a low pressure spray, or a shower spray. Faucet 1100 may comprise one or more spray mode controls 1108 configured to allow the faucet user to selectively switch between the plurality of spray modes. In some embodiments, spray mode controls 1108 may be positioned on spray head 1004. Spray mode controls 1108 may comprise one or more push buttons, pressure sensors, capacitive touch sensors, or switches.

In some embodiments, a portion of the plurality of water outlets 1112 may be arranged in a circular pattern or in two or more concentric circular patterns. In some embodiments, spray head 1104 may comprise greater than or equal to about 1, about 2, about 5, about 10, about 15, about 25, or about 50 water outlets 1112. In some embodiments, spray head 1104 may comprise less than or equal to about 100, about 50, about 25, about 15, or about 10 water outlets 1112. In some embodiments, spray head 1104 may comprise between about 1-5, about 1-10, about 10-15, about 15-25, about 25-50, or about 50-100 water outlets 1112.

In some embodiments, temperature control assembly 1106 may be configured to rotate about spray head 1104. A faucet user may provide user input related to a desired water temperature by rotating temperature control assembly 1106. Rotation of temperature control assembly 1106 may cause temperature control assembly 1106 to transmit one or more signals to a mixing valve in order to control the water temperature. In some embodiments, rotation of temperature control assembly 1106 in a first direction may cause the water temperature to increase, while rotation of temperature control assembly 1106 in a second direction that is opposite the first direction may cause the water temperature to decrease. For example, in some embodiments, clockwise rotation of temperature control assembly 1106 may cause the water temperature to increase while counterclockwise rotation of temperature control assembly 1106 may cause the water temperature to decrease. In some embodiments, rotating temperature control assembly 1106 by one degree may cause the water temperature to change (i.e., increase or decrease) by less than or equal to about 0.1, about 1, about 2, about 5, about 10, about 15, or about 20° F. In some embodiments, rotating temperature control assembly 1106 by one degree may cause the water temperature to change (i.e., increase or decrease) by greater than or equal to about 0.01, about 0.1, about 1, about 2, about 5, about 10, about 15, or about 20° F. In some embodiments, temperature control assembly 1106 may include features of temperature control assembly 1006 shown in FIGS. 10a-10b or features of temperature control assembly 906 shown in FIG. 9.

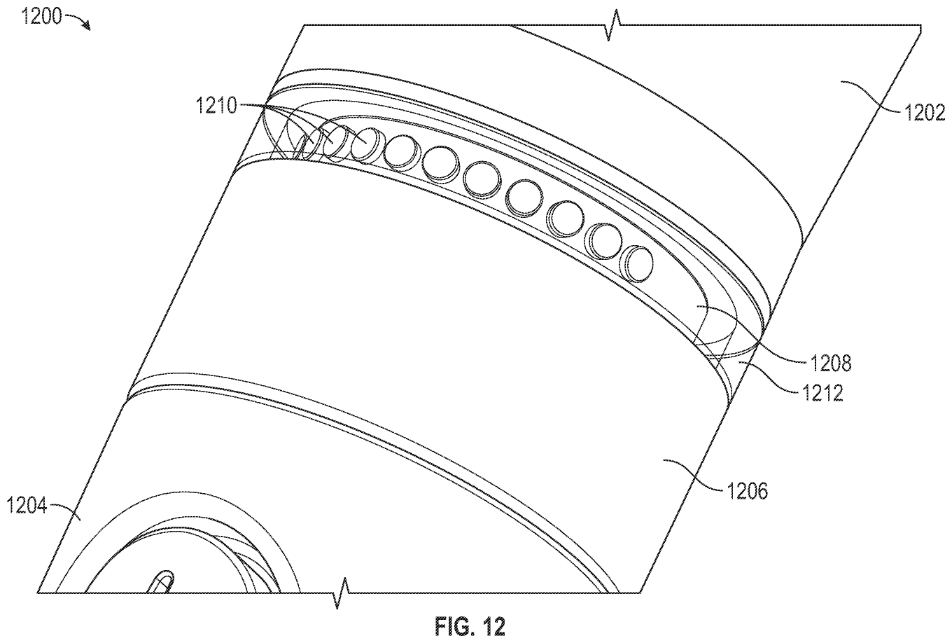

FIG. 12 illustrates an temperature control assembly according to some embodiments of the present disclosure. Specifically, FIG. 12 shows a faucet 1200 comprising a faucet body 1202, a spray head 1204, and a temperature adjustment ring 1206. Faucet body 1202 may be configured to receive water from a fluid source (e.g., fluid source 116 of FIG. 1) via a mixing valve (e.g., mixing valve 114 of FIG. 1). In some embodiments, temperature adjustment ring 1206 may be retained on faucet body 1202 at a position proximal to spray head 1204. Temperature adjustment ring 1206 may be configured to rotate about faucet body 1202. In some embodiments, when temperature adjustment ring 1206 is rotated about faucet body 1202 by a faucet user, temperature adjustment ring 1206 may be configured to transmit a signal to the mixing valve (or a mixing valve control such as mixing valve control 112 of FIG. 1) to control the temperature of water being received by faucet body 1202 from the fluid source. In some embodiments, rotation of temperature adjustment ring 1206 in a first direction may cause the water temperature to increase, while rotation of temperature adjustment ring 1206 in a second direction that is opposite the first direction may cause the water temperature to decrease.

In some embodiments, faucet 1200 may comprise a plurality of lights 1210 soldered to a printed circuit board 1208. In some embodiments, lights 1208 may be arranged in a linear pattern proximal to temperature adjustment ring 1206. In some embodiments, faucet 1200 may comprise greater than or equal to about 1, about 5, about 10, about 15, or about 20 lights 1210. In some embodiments, faucet 1200 may comprise less than or equal to about 50, about 30, about 20, about 15, about 10, or about 5 lights 1210. In some embodiments, faucet 1200 may comprise between about 1-5, about 5-10, about 10-15, about 15-20, about 20-25, or about 25-30 lights 1210. Lights 1210 may be configured to transmit visual signals to a faucet user based on a current water temperature and/or a user input provided by the faucet user indicating a desired water temperature. A greater number of lights 1210 may increase the complexity and precision of signals that faucet 1200 can provide to the faucet user.

In some embodiments, faucet 1200 may comprise a lens 1212 affixed atop printed circuit board 1208. Lens 1212 may comprise plastic and/or glass. In some embodiments, lens 1212 may be greater than or equal to about 0.01. about 0.1, about 0.3, about 0.5, about 0.7, about 0.9, about 1.1, about 1.5, or about 2 cm thick at its point of maximum thickness. In some embodiments, lens 1212 may be less than or equal to about 0.01. about 0.1, about 0.3, about 0.5, about 0.7, about 0.9, about 1.1, about 1.5, or about 2 cm thick at its point of maximum thickness. In some embodiments, lens 1212 may be between about 0-0.1, about 0.1-0.3, about 0.3-0.5, about 0.5-0.7, about 0.7-0.9, about 0.9-1.1, about 1.1-1.5, about 1.5-1.7, or about 1.7-2 cm thick at its point of maximum thickness.

In some embodiments, lights 1210 may be configured to emit light of any wavelength in the visible range of the electromagnetic spectrum. In some embodiments, one or more lights of lights 1210 may be configured to emit light of different wavelengths, possibly simultaneously. In some embodiments, each light of lights 1210 may be configured to emit the same wavelength of light at the same time. In some embodiments, the wavelength of light emitted by one or more lights of lights 1210 may change as the faucet user rotates temperature adjustment ring 1206 to indicate that they would like to increase or decrease their desired water temperature. In some embodiments, the wavelength of light emitted by lights 1210 may increase (e.g., the color of emitted light may shift toward an orange or a red color) as temperature adjustment ring 1206 is rotated in a first direction. In some embodiments, the wavelength of light emitted by lights 1210 may decrease (e.g., the color of emitted light may shift toward a blue or a violet color) as temperature adjustment ring 1206 is rotated in a second direction.

In some embodiments, the color of light emitted by lights 1210 may change based on user input received by temperature adjustment ring 1206. For example, if the faucet user indicates, using temperature adjustment ring 1206, that they wish faucet 1200 to deposit hot water, lights 1210 may be configured to emit light at a hot water indicator wavelength. In some embodiments, a hot water indicator wavelength may be less than or equal to about 750, about 625, about 590, or about 565 nm. In some embodiments, a hot water indicator wavelength may be greater than or equal to about 565, about 590, about 625, or about 750 nm. In some embodiments, a hot water indicator wavelength may be between about 500-565, about 565-590, about 590-625, or about 625-750 nm. Likewise, if the faucet user indicates, using temperature adjustment ring 1206, that they wish faucet 1200 to deposit cold water, lights 1210 may be configured to emit light at a cold water indicator wavelength. In some embodiments, a cold water indicator wavelength may be less than or equal to about 500, about 485, about 450, or about 380 nm. In some embodiments, a cold water indicator wavelength may be greater than or equal to about 380, about 450, about 485, or about 500 nm. In some embodiments, a cold water indicator wavelength may be between about 380-450, about 450-485, about 485-500, or about 500-565 nm.

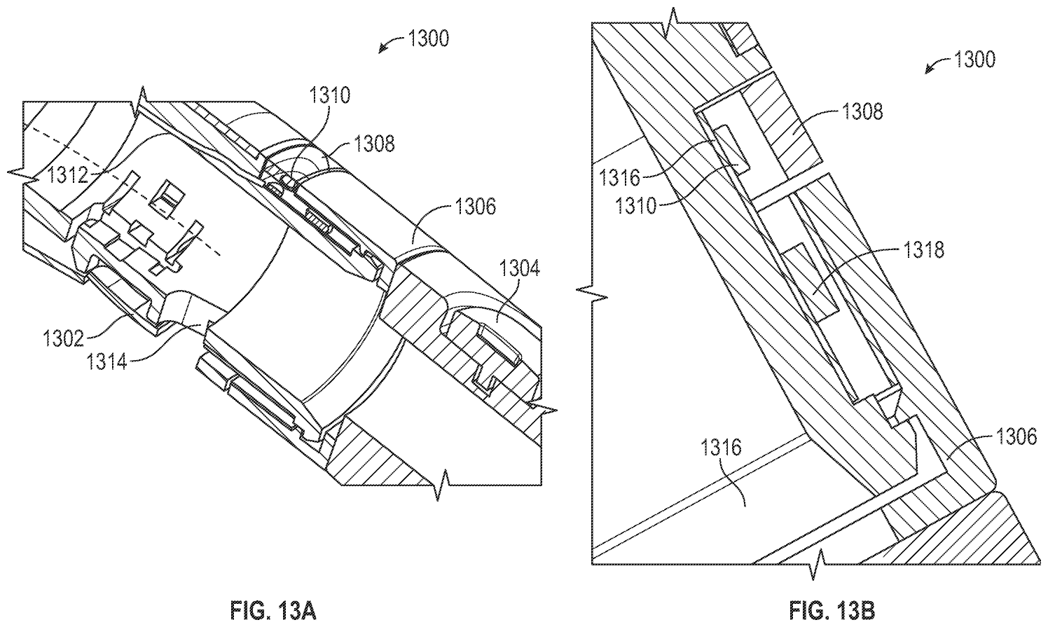

FIGS. 13A-13B illustrate perspective internal views of a faucet with an temperature control assembly according to some embodiments of the present disclosure. Specifically, FIGS. 13A-13B illustrate perspective views of a faucet 1300 comprising a faucet body 1302, a spray head 1304, and a temperature adjustment ring 1306 configured to receive user input from a faucet user and transmit signals to a mixing valve based on the received user input. In some embodiments, signals may be transmitted from temperature adjustment ring 1306 to a mixing valve via one or more cables 1312 positioned within a hose receptacle 1314 inside faucet body 1302. In some embodiments, signals may be transmitted from temperature adjustment ring 1306 to a mixing valve wirelessly (e.g., using radio waves or Bluetooth). Temperature adjustment ring 1306 may include features of temperature adjustment ring 1206 shown in FIG. 12.

In some embodiments, 1300 may comprise one or more lights 1310 soldered to a printed circuit board 1316. As shown, printed circuit board 1316 may be configured to mold to a boundary of faucet body 1302, i.e., printed circuit board 1316 may be flexible and configured to wrap around faucet body 1302. In some embodiments, lights 1310 may include features of lights 1210 shown in FIG. 12.

Temperature adjustment ring 1306 may be configured to control the water temperature by harnessing the Hall effect. Specifically, as shown in FIG. 13B, temperature adjustment ring 1306 may comprise one or more magnetic strips. This may cause temperature adjustment ring to emit a magnetic field. Printed circuit board 1316 may comprise a Hall effect sensor 1318 configured measure a magnitude of the magnetic field emitted by temperature adjustment ring 1306. As temperature adjustment ring 1306 is rotated about faucet body 1302 by a faucet user, the magnitude of the magnetic field emitted by temperature adjustment ring may vary. Based on the detected magnetic field magnitude, Hall effect sensor 1318 may be configured to determine a position of temperature adjustment ring 1306. Then, based on the determined position of temperature adjustment ring 1306, Hall effect sensor 1318 may be configured to transmit a signal to a mixing valve to control the temperature of water being transmitted to faucet 1300.

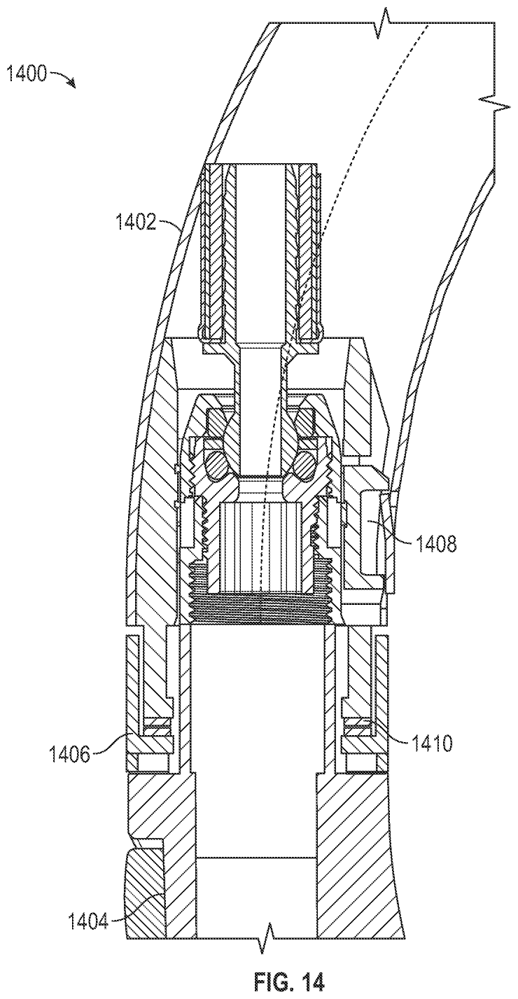

FIG. 14 illustrates a faucet with an temperature control assembly according to some embodiments of the present disclosure. Specifically, FIG. 14 shows a cross-sectional view of a faucet 1400 comprising a faucet body 1402, a spray head 1404, and a temperature adjustment ring 1406. Temperature adjustment ring 1406 may comprise features of temperature adjustment ring 1206 shown in FIG. 12 or temperature adjustment ring 1306 shown in FIG. 13. As shown, temperature adjustment ring 1406 may be positioned proximal to spray head 1404 along faucet body 1402.

In some embodiments, spray head 1404 may be a pull-down spray head or a pull-out spray head configured to detach from faucet body 1402. Faucet 1400 may comprise a spray head nesting engagement 1408 positioned within faucet body 1402. Spray head nesting engagement 1408 may be configured to hold spray head 1404 when spray head 1404 is not pulled down or pulled out. In some embodiments, temperature adjustment ring 1406 may be retained on spray head nesting engagement 1408 and configured to rotate about spray head nesting engagement 1408. In some embodiments, one or more swipe pads 1410 may be positioned between spray head nesting engagement 1408 and temperature adjustment ring 1406. In some embodiments, swipe pads 1410 may comprise one or more capacitive touch sensors configured to detect when a user makes a swiping motion with their finger in the vicinity of swipe pads 1410. In some embodiments, swipe pads 1410 may be configured to detect a position of temperature adjustment ring 1406. In some embodiments, based on the detected position of temperature adjustment ring 1406, swipe pads 1410 may be configured to transmit a signal to a mixing valve in order to control the temperature of water transmitted to faucet 1400.

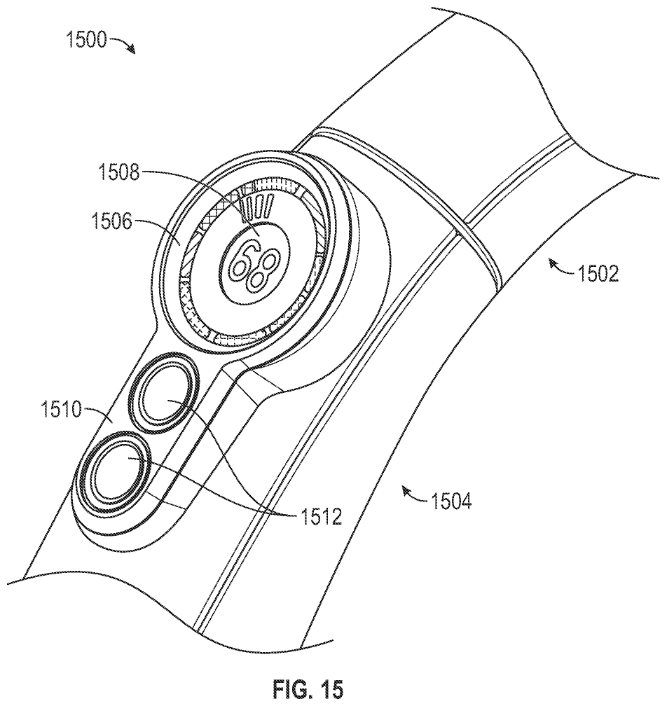

FIG. 15 illustrates a faucet with a temperature control assembly according to some embodiments of the present disclosure. Specifically, FIG. 15 shows a faucet 1500 comprising a faucet body 1502, a spray head 1504, and a temperature control assembly 1506. Faucet body 1502 may be configured to receive water from a fluid source (e.g., fluid source 116 shown in FIG. 1) via a mixing valve (e.g., mixing valve 114 shown in FIG. 1). Faucet body 1502 may comprise a water flow path configured to transmit water to spray head 1504. In some embodiments, water received by spray head 1504 may be transmitted by spray head 1504 into a water receptacle (e.g., a sink or a bathtub).

In some embodiments, temperature control assembly 1506 may include features of temperature control assembly 106 shown in FIG. 1. Temperature control assembly 1506 may be configured to receive user input from a faucet user containing information related to the faucet user's desired water temperature. In some embodiments, temperature control assembly 1506 may comprise a capacitive touch sensor. In some embodiments, temperature control assembly 1506 may comprise a pressure sensor. In some embodiments, temperature control assembly 1506 may be configured to detect when a gesture or a swipe made by the faucet user. In some embodiments, temperature control assembly 1506 may be configured to transmit a signal based on the received user input to the mixing vale (or to a mixing valve control such as mixing valve control 112 shown in FIG. 1) to control the temperature of water received by faucet body 1502. In some embodiments, temperature control assembly 1506 may comprise a temperature display 1508 configured to display a current water temperature and/or the faucet user's desired water temperature.

In some embodiments, faucet 1500 may be configured to provide a plurality of spray modes. Faucet 1500 may comprise one or more spray mode controls 1510, each of which may be configured to initiate a different spray mode. In some embodiments, spray mode controls 1510 may comprise one or more capacitive touch sensors, pressure sensors, or push buttons. In some embodiments, faucet 1500 may comprise greater than or equal to about 1, about 2, about 3, about 4, about 5, or about 10 spray mode controls 1510. In some embodiments, faucet 1500 may comprise less than or equal to about 15, about 12, about 10, about 8, about 5, about 4, or about 3 spray mode controls 1510. In some embodiments, at least one of spray mode controls 1510 may be configured to turn faucet 1500 on.

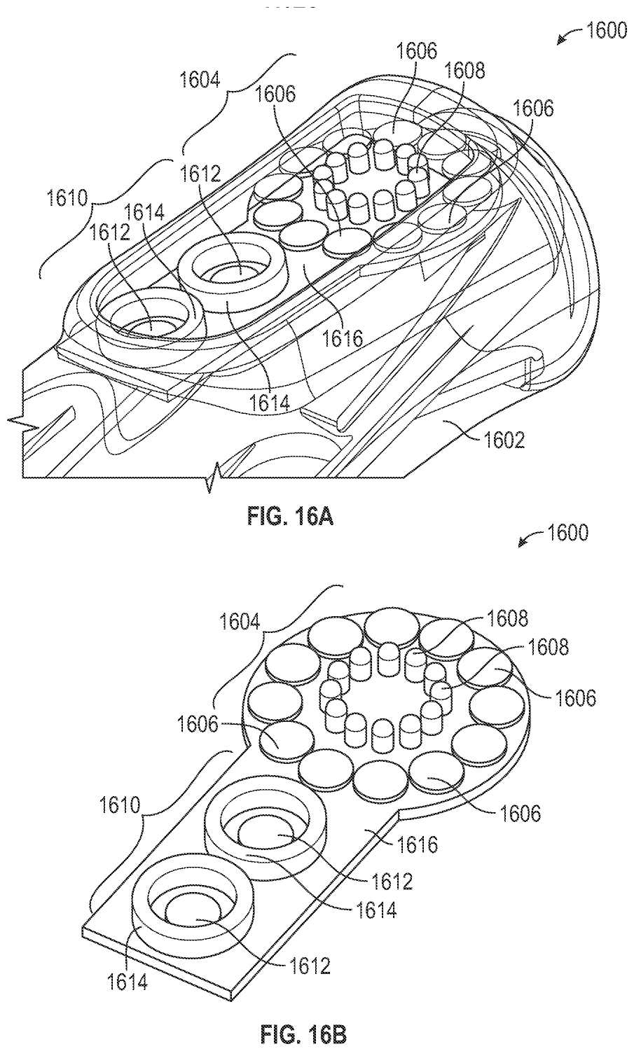

FIGS. 16A-16B illustrate a temperature control assembly according to some embodiments of the present disclosure. Specifically, FIGS. 16A-16B show a faucet 1600 comprising a temperature control assembly 1604 disposed within a faucet body 1602. Temperature control assembly 1604 may comprise a plurality of capacitive touch sensors 1606 and a plurality of lights 1608 arranged in concentric circular patterns and soldered to a printed circuit board 1616. Capacitive touch sensors 1606 may be configured to receive a user input indicating a desired water temperature when a faucet user touches or swipes one or more of capacitive touch sensors 1606. Upon receiving the user input, capacitive touch sensors 1606 may be configured to transmit a signal to a mixing valve in order to adjust a water temperature in faucet 1600. In some embodiments, faucet 1600 may comprise greater than or equal to about 1, about 2, about 3, about 4, about 5, about 10, or about 15 capacitive touch sensors 1606. In some embodiments, faucet 1600 may comprise less than or equal to about 30, about 20, about 15, about 12, about 10, about 8, or about 5 capacitive touch sensors 1606.

In some embodiments, upon receiving user input from the faucet user, capacitive touch sensors 1606 may be configured to transmit a signal to lights 1608. In some embodiments, faucet 1600 may comprise greater than or equal to about 1, about 5, about 10, about 15, or about 20 lights 1608. In some embodiments, faucet 1600 may comprise less than or equal to about 50, about 30, about 20, about 15, about 10, or about 5 lights 1608. In some embodiments, faucet 1600 may comprise between about 1-5, about 5-10, about 10-15, about 15-20, about 20-25, or about 25-30 lights 1608. Lights 1608 may be configured to transmit visual signals to a faucet user based on a current water temperature and/or a user input provided by the faucet user indicating a desired water temperature. A greater number of lights 1608 may increase the complexity and precision of signals that faucet 1600 can provide to the faucet user.

In some embodiments, lights 1608 may be configured to emit light of any wavelength in the visible range of the electromagnetic spectrum. In some embodiments, one or more lights of lights 1608 may be configured to emit light of different wavelengths, possibly simultaneously. In some embodiments, each light of lights 1607 may be configured to emit the same wavelength of light at the same time. In some embodiments, the wavelength of light emitted by one or more lights of lights 1608 may change as the faucet user provides input to capacitive touch sensors 1606 to indicate that they would like to increase or decrease their desired water temperature. In some embodiments, the wavelength of light emitted by lights 1608 may increase (e.g., the color of emitted light may shift toward an orange or a red color) as the faucet user swipes along capacitive touch sensors 1606 in a first direction. In some embodiments, the wavelength of light emitted by lights 1608 may decrease (e.g., the color of emitted light may shift toward a blue or a violet color) as the faucet user swipes along capacitive touch sensors 1606 in a first direction.

In some embodiments, the color of light emitted by lights 1608 may change based on user input received by capacitive touch sensors 1606. For example, if the faucet user indicates, using capacitive touch sensors 1606, that they wish faucet 1600 to deposit hot water, lights 1608 may be configured to emit light at a hot water indicator wavelength. In some embodiments, a hot water indicator wavelength may be less than or equal to about 750, about 625, about 590, or about 565 nm. In some embodiments, a hot water indicator wavelength may be greater than or equal to about 565, about 590, about 625, or about 750 nm. In some embodiments, a hot water indicator wavelength may be between about 500-565, about 565-590, about 590-625, or about 625-750 nm. Likewise, if the faucet user indicates, using capacitive touch sensors 1606, that they wish faucet 1600 to deposit cold water, lights 1608 may be configured to emit light at a cold water indicator wavelength. In some embodiments, a cold water indicator wavelength may be less than or equal to about 500, about 485, about 450, or about 380 nm. In some embodiments, a cold water indicator wavelength may be greater than or equal to about 380, about 450, about 485, or about 500 nm. In some embodiments, a cold water indicator wavelength may be between about 380-450, about 450-485, about 485-500, or about 500-565 nm.

In some embodiments, faucet 1600 may comprise one or more spray controls 1610. Spray controls 1610 may be configured to control one or more spray modes which may be provided by faucet 1600. In some embodiments, spray controls 1610 may comprise one or more capacitive touch sensors 1612, each of which may be disposed within ring lights 1614. In some embodiments, upon receiving a user input from a faucet user, capacitive touch sensors 1612 may be configured to transmit a signal to ring lights 1614 to cause ring lights 1614 to emit light. This may provide a visual signal to the faucet user indicating the faucet user's chosen spray mode.

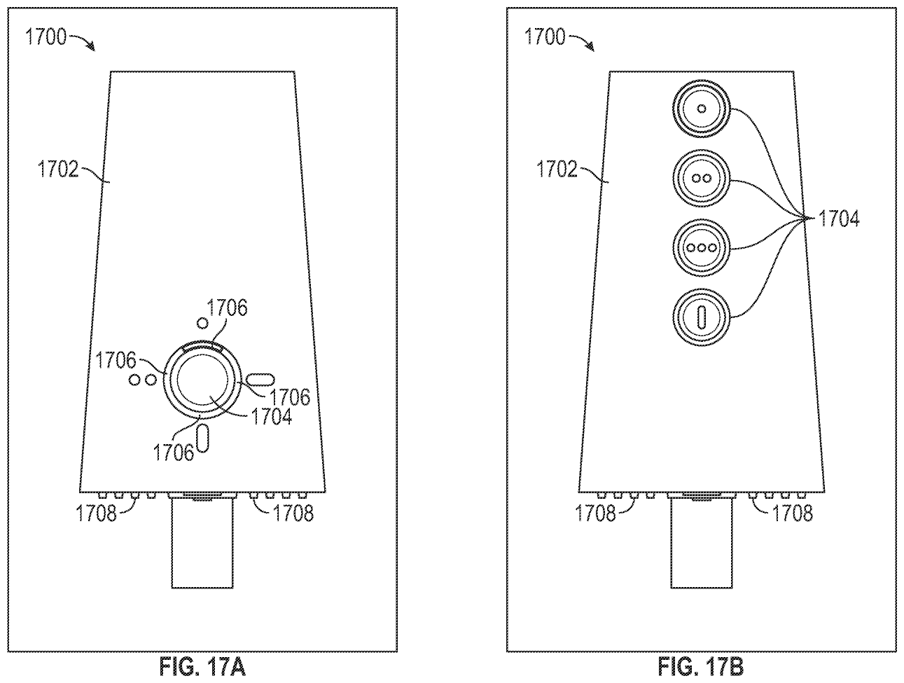

FIGS. 17A-17B illustrate spray control mechanisms for faucets according to some embodiments of the present disclosure. Specifically, FIGS. 17A-17B illustrate a faucet 1700 comprising a spray head 1702. Spray head 1702 may comprise a plurality of water outlets 1708 configured to receive water from spray head 1702 and transmit the water to a water receptacle (e.g., a sink or a bathtub). Faucet 1700 may be configured to provide a variety of spray modes by controlling which water outlets of water outlets 1708 receive water from spray head 1702. In some embodiments, the variety of spray modes may include a high pressure/“jet” spray mode, an aerated spray mode, a low pressure/“gentle” spray mode, or a filtered spray mode.

FIG. 17A shows a first exemplary configuration of a spray control mechanism for a faucet. As shown, in some embodiments, faucet 1700 may comprise a single spray control 1704 disposed on spray head 1702. In some embodiments, spray control 1704 may be a push button. In some embodiments, spray control 1704 may be a capacitive touch sensor. In some embodiments, spray control 1704 may be a pressure sensor. Spray control 1704 may comprise one or more spray mode regions 1706 configured to receive user input from a faucet user. Upon receiving user input, each of the one or more spray mode regions 1706 may be configured to initiate a different spray mode. In some embodiments, spray control 1704 may comprise greater than or equal to about 1, about 2, about 3, about 4, about 5, about 8, or about 10 spray mode regions 1706. In some embodiments, spray control 1704 may comprise less than or equal to about 15, about 10, about 8, about 5, about 4, about 3, or about 2 spray mode regions 1706.

FIG. 17B shows a second exemplary configuration of a spray control mechanism for a faucet. As shown, in some embodiments, faucet 1700 may comprise a plurality of spray controls 1704. In some embodiments, the plurality of spray controls 1704 may be arranged in a line along spray head 1702. In some embodiments, the plurality of spray controls 1704 may be arranged circumferentially around spray head 1704. In some embodiments, the plurality of spray controls 1704 may comprise one or more push buttons. In some embodiments, the plurality of spray controls 1704 may comprise one or more capacitive touch sensors. In some embodiments, the plurality of spray controls 1704 may comprise one or more pressure sensors. Each of the plurality of spray controls 1704 may be configured to receive user input from a faucet user and initiate a predetermined spray mode based on the user input. In some embodiments, faucet 1700 may comprise greater than or equal to about 2, about 3, about 4, about 5, about 8, or about 10 spray controls 1704. In some embodiments, faucet 1700 may comprise less than or equal to about 15, about 10, about 8, about 5, about 4, or about 3 spray controls 1704.

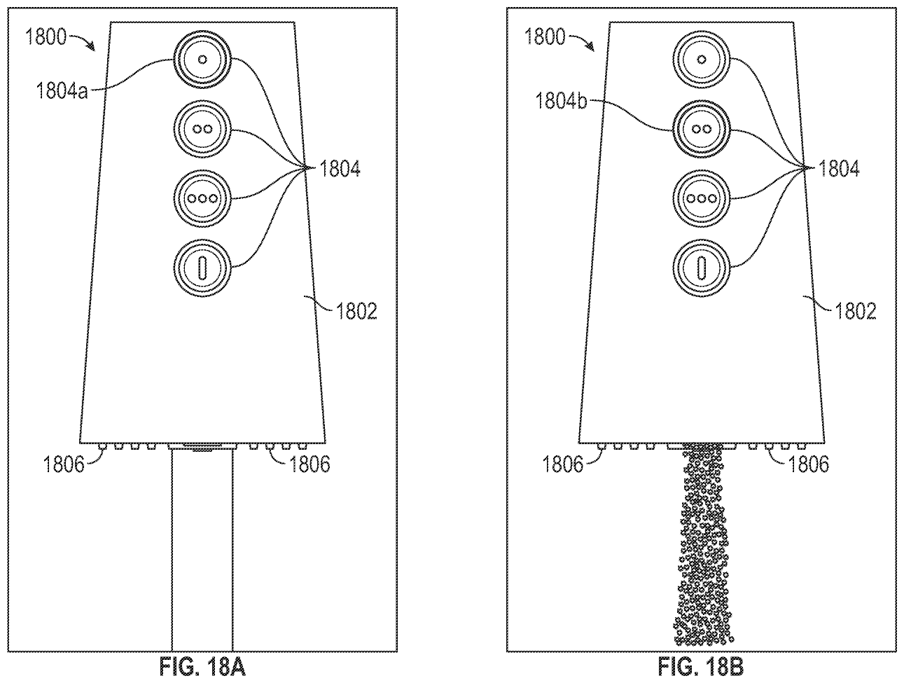

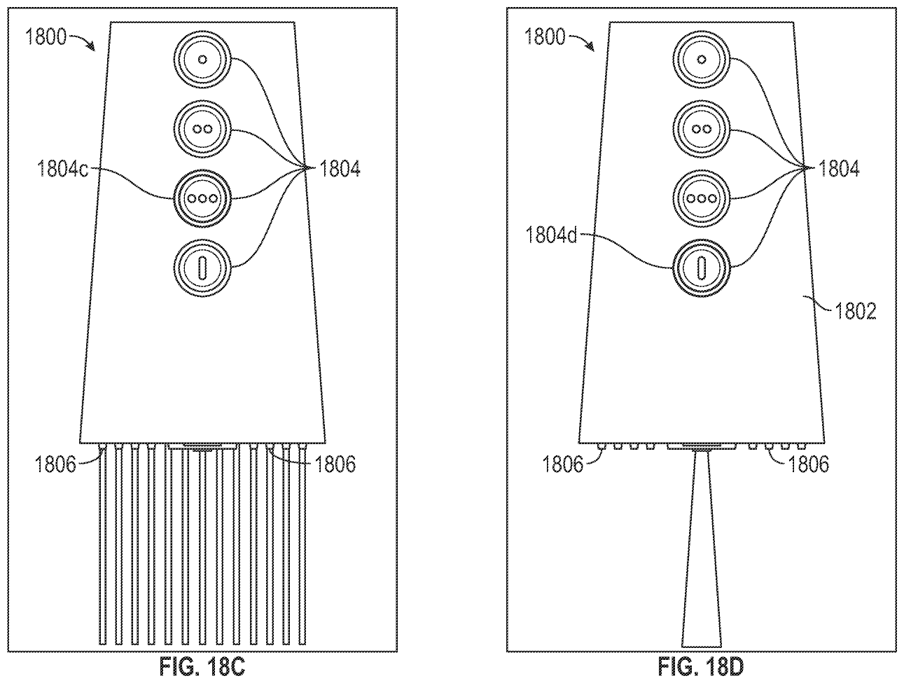

FIGS. 18A-18D illustrate spray mode for faucets according to some embodiments of the present disclosure. Specifically, FIGS. 18A-18D illustrate a faucet 1800 comprising a spray head 1802 and a plurality of water outlets 1806. Faucet 1800 may be configured to provide a plurality of spray modes which may be configured to be initiated when a faucet user selects one of a plurality of spray controls 1804.

FIG. 18A shows faucet 1800 providing a centralized spray mode wherein water transmission through water outlets 1806 is restricted to water outlets 1806 located within a predetermined distance of the center of spray head 1804. In some embodiments, a faucet user may initiate the centralized spray mode by providing user input to a first spray control 1804a of the plurality of spray controls 1804.

FIG. 18B shows faucet 1800 providing an aerated spray mode configured to cause water to be aerated by an aerator before being transmitted through water outlets 1806. In some embodiments, a faucet user may initiate the aerated spray mode by providing user input to a second spray control 1804b of the plurality of spray controls 1804.

FIG. 18C shows faucet 1800 providing a dispersed spray mode configured to cause water to be transmitted through all (or almost all) of water outlets 1806. In some embodiments, a faucet user may initiate the dispersed spray mode by providing user input to a third spray control 1804c of the plurality of spray controls 1804.

FIG. 18D shows faucet 1800 providing a high pressure spray mode configured to cause water to be transmitted one or more water outlets 1806 at a higher-than-average pressure. In some embodiments, a faucet user may initiate the high pressure spray mode by providing user input to a fourth spray control 1804d of the plurality of spray controls 1804.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

In addition, it is also to be understood that the singular forms “a”, “an”, and “the” used in the following description are intended to include the plural forms as well, unless the context clearly indicates otherwise. It is also to be understood that the term “and/or” as used herein, refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A faucet assembly comprising:
a faucet body comprising:
a fluid inlet configured to fluidly connect to a mixing valve of a fluid source and receive fluid from the fluid source by way of the mixing valve;
a fluid flow path within the faucet body fluidly connected to the fluid inlet and configured to receive fluid from the fluid inlet; and
a spray head comprising one or more fluid outlets fluidly connected to the fluid flow path and configured to dispense fluid out of the faucet body; and
a temperature control system positioned on the faucet body proximate to the spray head, the temperature control system comprising:
a printed circuit board;
one or more controls disposed on the printed circuit board and configured to receive a user input comprising a user's desired fluid temperature;
one or more lights disposed on the printed circuit board and configured to emit light based on the user input; and
one or more circuit traces disposed on the printed circuit board and configured to electronically connect to the mixing valve, the one or more controls, and the one or more lights;
wherein, upon receiving the user input, the one or more controls are configured to transmit a signal to the mixing valve via the one or more circuit traces to cause the mixing valve to control a temperature of the fluid based on the user's desired fluid temperature.

2. The faucet assembly of claim 1, wherein the one or more controls of the temperature control system comprise one or more capacitive touch sensors.

3. The faucet assembly of claim 1, wherein the one or more controls of the temperature control system comprise one or more pressure sensors.

4. The faucet assembly of claim 1, wherein the one or more controls of the temperature control system comprise one or more push buttons.

5. The faucet assembly of claim 1, wherein the one or more controls of the temperature control system are arranged in a linear pattern or a circular pattern.

6. (canceled)

7. The faucet assembly of claim 1, wherein the faucet assembly is configured to provide a plurality of spray modes.

8. The faucet assembly of claim 7, wherein the faucet body further comprises a spray mode control comprising one or more spray mode regions, wherein each spray mode region is associated with a spray mode of the plurality of spray modes, and wherein each spray mode region is configured to:
receive a spray mode input from the user; and
control a flow of fluid through the one or more fluid outlets in order to initiate the spray mode associated with the spray mode region.

9. The faucet assembly of claim 8, wherein the spray mode control comprises at least four spray mode regions.

10. The faucet assembly of claim 8, wherein the spray mode control is a push button.

11. The faucet assembly of claim 8, wherein the spray mode control is a capacitive touch sensor.

12. The faucet assembly of claim 8, wherein the spray mode control is a pressure sensor.

13. The faucet assembly of claims 7, wherein the faucet body further comprises a plurality of spray mode controls, wherein each of the plurality of spray mode controls is associated with a spray mode of the plurality of spray modes, and wherein each of the plurality of spray mode controls is configured to:
receive a spray mode input from the user; and
control a flow of fluid through the one or more fluid outlets in order to initiate the spray mode associated spray mode control.

14. The faucet assembly of claim 13, wherein the plurality of spray mode controls comprises at least four spray mode controls.

15. The faucet assembly of claim 13, wherein the plurality of spray mode controls comprises at least one push button.

16. The faucet assembly of claim 13, wherein the plurality of spray mode controls comprises at least one capacitive touch sensor.

17. The faucet assembly of claim 13, wherein the plurality of spray mode controls comprises at least one pressure sensor.

18. The faucet assembly of claim 1, wherein the spray head is configured to pull away from the spout.

19. The faucet assembly of claim 1, wherein the one or more lights are configured to emit light in a first wavelength range if the user's desired fluid temperature is within a first temperature range and are configured to emit light in a second wavelength range if the user's desired fluid temperature is within a second temperature range.

20. The faucet assembly of claim 19, wherein the first wavelength range is 500-750 nm.

21. The faucet assembly of claim 19, wherein the second wavelength range is 350-500 nm.

22-58. (canceled)
